(19) United States
(12) Patent Application Publication
(10) Pub. No.: US 2016/0207845 A1
(43) Pub. Date: Jul. 21, 2016

(54) COMPOSTING DEVICE

(71) Applicant: Whirlpool Corporation, Benton Harbor, MI (US)

(72) Inventors: KRISTOPHER L. DELGADO, STEVENSVILLE, MI (US); JEFFREY J. JACOBS, HAMMOND, IN (US); CHRISTOPHER CAMP, MORTON, IL (US); JANGLIH LIN, NORMAL, IL (US); SUZANNE M. BERBERET, SAINT JOSEPH, MI (US); WALTER T. BLANCHARD, IRVING, TX (US); BRENT M. BURGESS, EDWARDSBURG, MI (US); BRETT DIBKEY, SAINT JOSEPH, MI (US); DONALD J. HABEGGER, FINDLAY, OH (US); ANDREW KASPROWICZ, FORT SMITH, AR (US); EARL W. MANN, GREENWOOD, AR (US); WILLIAM L. MURCH, OWASSO, OK (US); JACK F. PARK, BENTON HARBOR, MI (US); WESLEY A. SONNENBERG, STEVENSVILLE, MI (US)

(21) Appl. No.: 15/080,734

(22) Filed: Mar. 25, 2016

Related U.S. Application Data
(63) Continuation of application No. 13/852,219, filed on Mar. 28, 2013.
Application No. 13/852,219 is a continuation of application No. 13/952,883, filed on Jul. 29, 2013, now Pat. No. 9,308,535.
(60) Provisional application No. 61/619,569, filed on Apr. 3, 2012.
(60) Provisional application No. 61/641,942, filed on May 3, 2012.

(51) Int. Cl. C05F 17/02; B02C 23/02; B02C 18/00

(52) U.S. Cl. CPC C05F 17/0258; B02C 18/0084; B02C 23/02

(57) ABSTRACT

A device for transforming refuse into compost according to a cycle of operation has a cabinet, a first chamber, a first reducing mechanism in the hopper, a transfer mechanism disposed in a conduit from the first chamber to an outlet, a motor beneath the first chamber and the transfer mechanism, a container beneath the outlet to receive ground refuse from the outlet, wherein the container is accessible from outside the cabinet, and a cleaning mechanism operative to clean the first chamber.

### CROSS REFERENCE TO RELATED APPLICATIONS

This application is a continuation of U.S. application Ser. No. 13/852,219, filed Mar. 28, 2013, which claims the benefit of U.S. Provisional Application Ser. No. 61/619,569, filed Apr. 3, 2012 and also claims the benefit of U.S. Provisional Application Ser. No. 61/641,942, filed May 3, 2012, all of which are incorporated herein by reference in their entireties.

This application is also a continuation of U.S. application Ser. No. 13/952,883, filed Jul. 29, 2013, which is herein incorporated by reference in its entirety.

### BACKGROUND

Composting devices are known to implement a composting cycle for biologically and chemically decomposing refuse, such as organic food waste, into compost for use as a fertilizer and soil amendment. The composting cycle may be implemented in a composting bin by providing water, heat and aeration to the refuse, and may require a period of time for completion. Composting devices usually require a large floor space and/or a large volume for installation. Further, some composting devices may be a batch type device, therefore may not be effective in producing compost in a continuous way.

### BRIEF SUMMARY

The invention relates to a device for transforming refuse into compost. The device for transforming refuse into compost includes a cabinet, a first chamber configured to receive refuse, and a first reducing mechanism in the first chamber operable to grind the refuse. A transfer mechanism is disposed in a conduit extending upwardly from the first chamber to an outlet in the upper portion of the cabinet. A motor is disposed beneath the first chamber and the transfer mechanism and operably connected to the first reducing mechanism and the transfer mechanism to operate the first reducing mechanism and the transfer mechanism. A container is removably mounted within the cabinet adjacent the motor and beneath the outlet to receive ground refuse from the outlet. The container is accessible from outside the cabinet. A cleaning mechanism is operative to clean the first chamber.

### BRIEF DESCRIPTION OF THE DRAWINGS

In the drawings:

FIG. 1 is a perspective view of a device in the form of a composting device for transforming refuse into compost according to a first embodiment of the invention.

FIG. 2 is a perspective view of the composing device of FIG. 1, where side walls are removed for illustrating the components of the composting device.

FIG. 3 is a perspective view of the composting device of FIG. 2, viewed from the left side of the composting device, with a top wall and a supporting plate removed.

FIG. 4 is a perspective view of the composting device of FIG. 2, viewed from the right side of the composting device, with a top wall and a supporting plate removed.

FIG. 5 is a perspective view of the composting device of FIG. 2, viewed from the bottom of the composting device, with front and side walls and the supporting plate removed.

FIG. 6 is a cross sectional side view of the composting device of FIG. 1, wherein the access door is in the open position.

FIG. 7 is a schematic of a controller of the composting device of FIG. 1.

FIG. 8 is a cross sectional side view of the composting device of FIG. 1, wherein an access door is in the closed position.

FIG. 9 is a perspective view of the composting device according to a second embodiment of the invention, where both an auger and a reducing system are provided with or for operating independently from each other.

FIG. 10 is a perspective view of the device;

FIG. 11 is a perspective view of the device showing the curing containers;

FIG. 12 is a cross-sectional view of the device of FIG. 10 taken along lines 12-12;

FIG. 13 is a view of FIG. 12 showing a manifold;

FIG. 14 is a perspective view of an embodiment of the grinding mechanism;

FIG. 15 is a cross-sectional view of the device of FIG. 12 taken along lines 15-15, showing a top down view of the shearing mechanism;

FIG. 16 is a cross-sectional view of the second chamber showing an embodiment of the agitator;

FIG. 17 is a top down view of the agitator of FIG. 16;

FIG. 18 is a cross-sectional view of the second chamber showing another embodiment of the agitator;

FIG. 19 is a cross-sectional view of an embodiment of the storage container;

FIG. 20 is a cross-sectional view of the storage container of FIG. 19 taken along lines 20-20;

FIG. 21 is a perspective view of the storage container of FIG. 20 being mounted onto the device;

FIG. 22 is a cross-sectional view of yet another embodiment of the storage container showing the rotatable door;

FIG. 23 is a perspective view of an embodiment of the storage container;

FIG. 24 is a view of the storage container of FIG. 23 showing the bottom floor opening; and

FIG. 25 is a view showing the baffles mounted to the inner wall of the first chamber.

### DETAILED DESCRIPTION

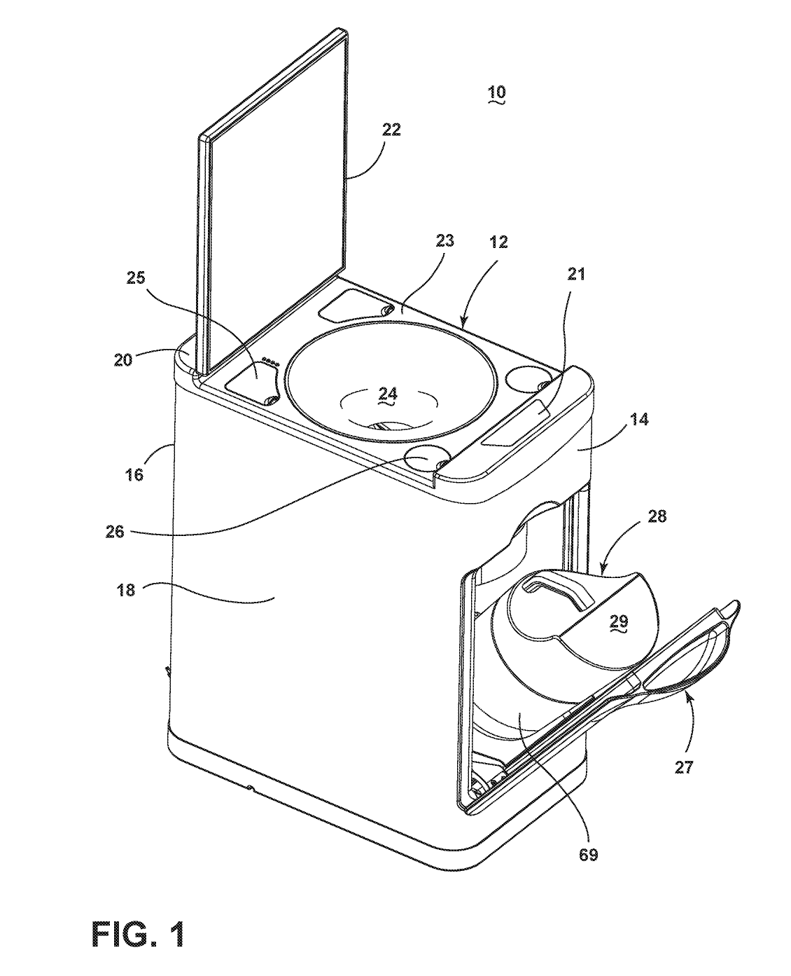

FIG. 1 illustrates a perspective view of a device 10 in the form of a composter for transforming refuse into compost according to a first embodiment of the invention. The composting device 10 may include a cabinet 12 having a front wall 14 spaced from a back wall 16, and a pair of side walls 18 extending between the front and back walls 14, 16.

A top wall 20 may enclose the cabinet 12 at the top of the front wall 14, back wall 16, and the pair of side walls 18. The top wall 20 may include a cover 22 pivotally mounted to a portion of the top wall 20 for movement between open or closed positions, and to enable access to other components of the cabinet 12. In other embodiments, the cover 20 is slidably mounted or removably mounted to a top portion of the top wall 20. The top wall 20, as well as the remainder of the cabinet 12, may be formed of a rigid and durable material such as steel, a metal alloy, or a hardened polymer composite material.

A controller (not shown) may be located within the device 10, and may be operably coupled with a user interface 21 for receiving user-selected inputs and communicating information to the user. The user interface 21 may be provided on a portion of the top wall 20 for communicating with the user. The user interface 21 may include operational controls such as dials, lights, switches, and displays enabling the user to input commands to the controller and receive information about a cycle of operation.

A portion 23 of the top wall 20 is configured to receive the cover 22 and defines an opening 24 positioned beneath the cover 22 in the closed position. The opening 24 exposes the interior of the cabinet 12. The portion 23 may also include one or more water fill inlets 25 for supplying water to the composting device 10, and one or more enzyme dispenser inlets 26.

The front wall 14 may include an access door 27, which may be movably connected to a side of the cabinet 12 as at the front wall 14 for access to the interior. As illustrated, the access door 27 is pivotally connected to the front wall 14 on a horizontal axis for movement between open and closed positions. It will be understood, however, that the access door 27 may be movably connected to the cabinet 12 in other ways. For example, the access door 27 may be pivotally connected to the front wall 14 on a vertical axis. In another example, the access door 24 may be slidably movable between the open position and the closed position. As well as it may be movably connected to a side wall 18.

A container 28 may be mounted to an internal side of the access door 27 where it is accessible from outside the cabinet 12 when the access door is in an open position. For example, the container 28 may be detachably mounted to the access door 27 by a bayonet mounting where twisting it in a clockwise or counter clockwise direction by ¼ or ½ turn will detach or attach the container relative to the access door 24. It will be understood that the container 28 may not need to be mounted to the access door 27 in another embodiment. For example, the container 28 may be positioned in the interior 32 of the cabinet, without explicitly being mounted to the access door 27. The container 28 may include at least one opening 29 for purposes described hereinafter. The container 28 need not be mounted to the access door 27; rather it is important that the container be accessible from outside the cabinet and that it be removable so that the contents thereof can be discharged at will by a user, as for example, by dumping the contents of the container through the opening 29 onto a garden.

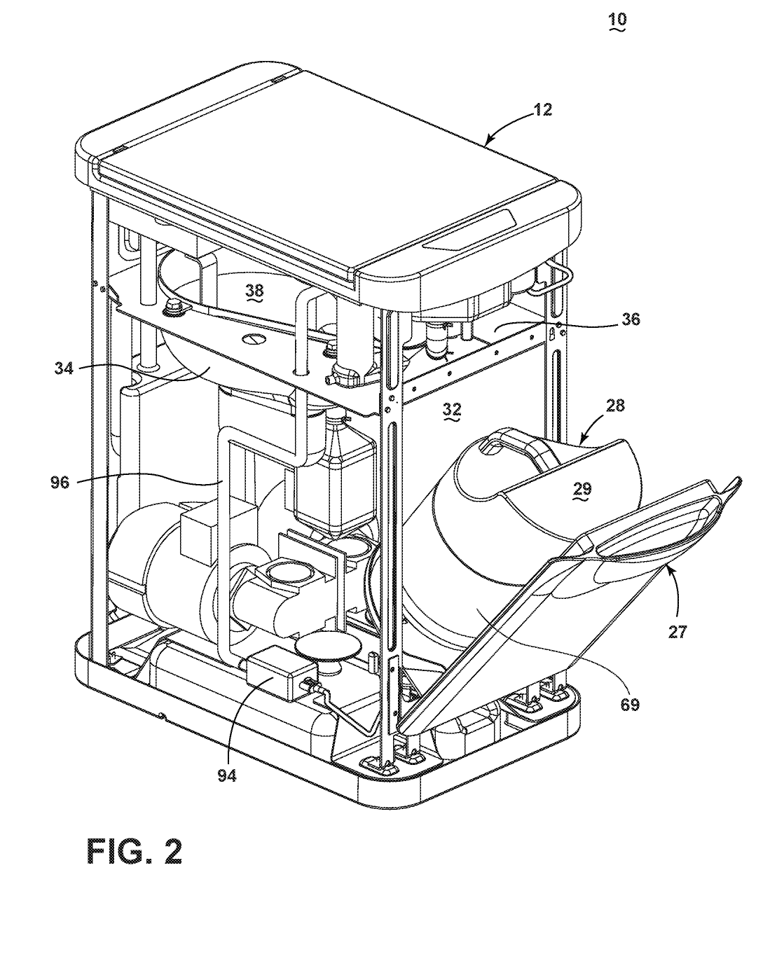

Referring now to FIGS. 2-6, an arrangement of various components in the cabinet interior 32 is illustrated. The cabinet 12 may include a hopper 30 positioned at an upper portion of the cabinet 12, and the hopper 30 may include a top portion 33 and a bottom portion 34. The hopper 30 may be fixedly mounted to the cabinet 12. For example, as illustrated in FIG. 2, the bottom portion 34 of the hopper 30 may be nested within an opening formed in a horizontally extending supporting plate 36, which, in turn, is fixedly coupled to the cabinet 12 by means of a plurality of fasteners such as screws, bolts or nuts. The hopper 30, as a whole, may define a chamber 38 where the top portion 33 has an opening adjacent to the opening 24 in the top wall 20 configured to receive refuse from outside of the composting device 10. The chamber 38 may be concave shaped, such as a bowl.

A conduit 40 may also extend upwardly from one side of the hopper 30 at a predetermined angle a with respect to a horizontal plane 42, preferably from a lower portion of the hopper 30 toward the front of the cabinet and the access door 27, and may include an outlet 44 at an upper portion of the cabinet away from the hopper. A transfer mechanism 50 such as a rotatable auger may be disposed in the conduit 40 for rotating in a clockwise or counter clockwise direction with respect to its rotational axis 52. The rotatable auger 50 may be configured such that a lower end portion of the rotatable auger 50 may be positioned at the lower portion of the hopper 30, while the upper end portion of the rotatable auger 50 may extend through the outlet 44 of the conduit 40 at the upper portion of the cabinet. The hopper 30 may also include a transfer downspout 54. The transfer downspout 54 may be configured to downwardly extend from the outlet 44 of the conduit 40. Other transfer mechanisms 50 may include a conveyor or a gravitational chute or the like.

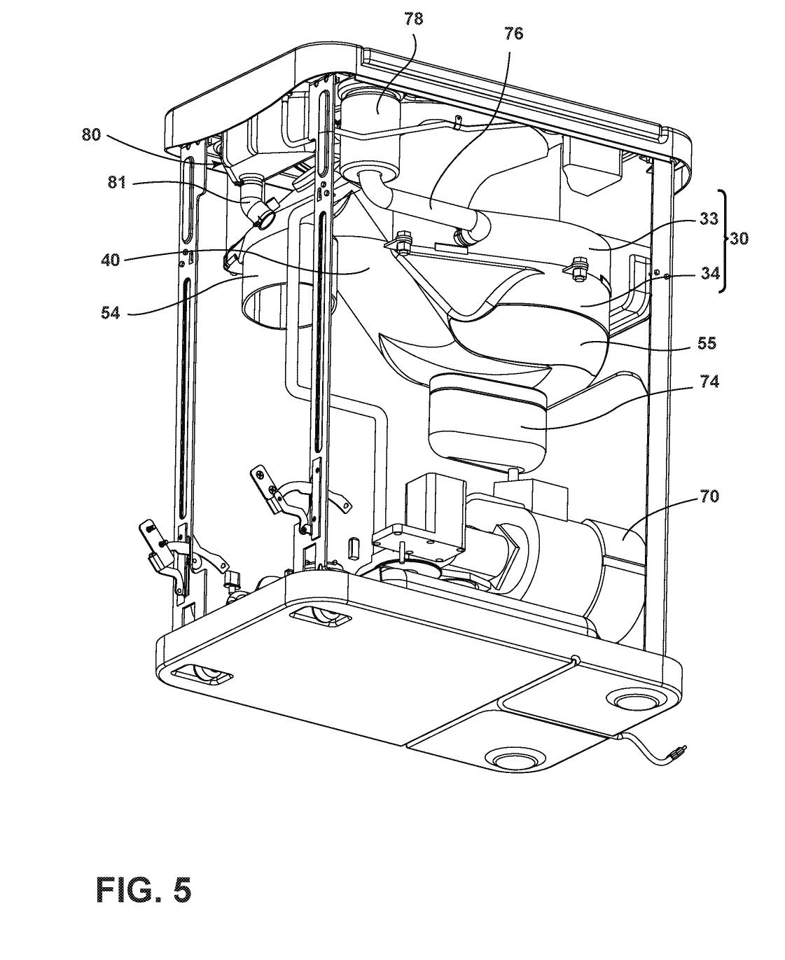

A first heating element 55 may be coupled to the exterior of the hopper 30 for controllably providing heat energy to the refuse received in the interior of the hopper 30. As illustrated in FIG. 5, the first heating element 55 may be a stick-on heater mounted to the exterior of the hopper 30. For example, the first heating element 55 may be in the form of a blanket heater and mounted to a portion of exterior surface of the hopper 30. In another example, a sheath heater may be mounted to the exterior of the hopper 30. It may be understood that the first heating element 55 may be mounted at any portion of the hopper 30. In one example, the first heating element 55 may be mounted at the lower portion, such as a bottom area, of the hopper 30.

An enzyme dispenser 56 may be disposed in the cabinet and accessible via an enzyme dispenser inlet 26. Preferably the enzyme dispenser 56 will be positioned to dispense enzyme into the container 28 when the access door 27 is in a closed position with the container inside the cabinet for maintaining the functionality of proteins in the composting process. The enzyme dispenser 56 may include a conduit (not shown), which may be fluidly coupled to the downwardly extending transfer downspout 54.

While the enzyme dispenser 56 may dispense enzymes, other bio-components may also be dispensed by the enzyme dispenser 56. One example of enzyme for the enzyme dispenser 56 is Biomix®, which can be in the form of a compressed solid puck and may include one or more enzymes, bacteria, fungi, or any combination thereof. The enzyme dispenser 56 may be configured to hold a plurality of Biomix® pucks. In another embodiment, Biomix® may be provided and dispensed in the form of a powder.

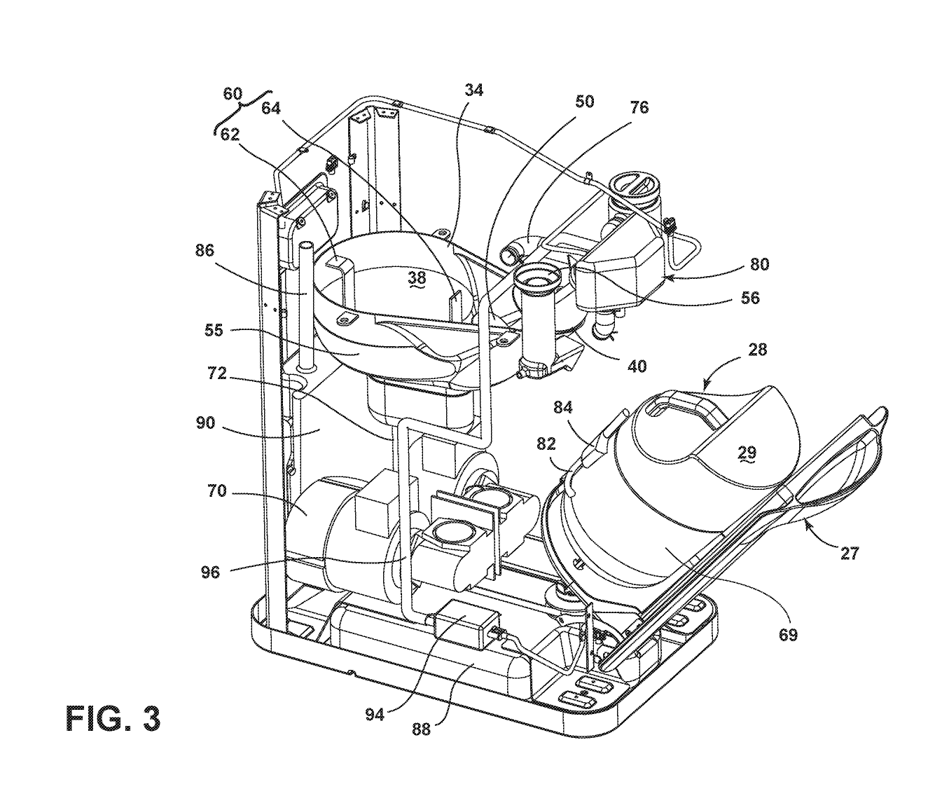

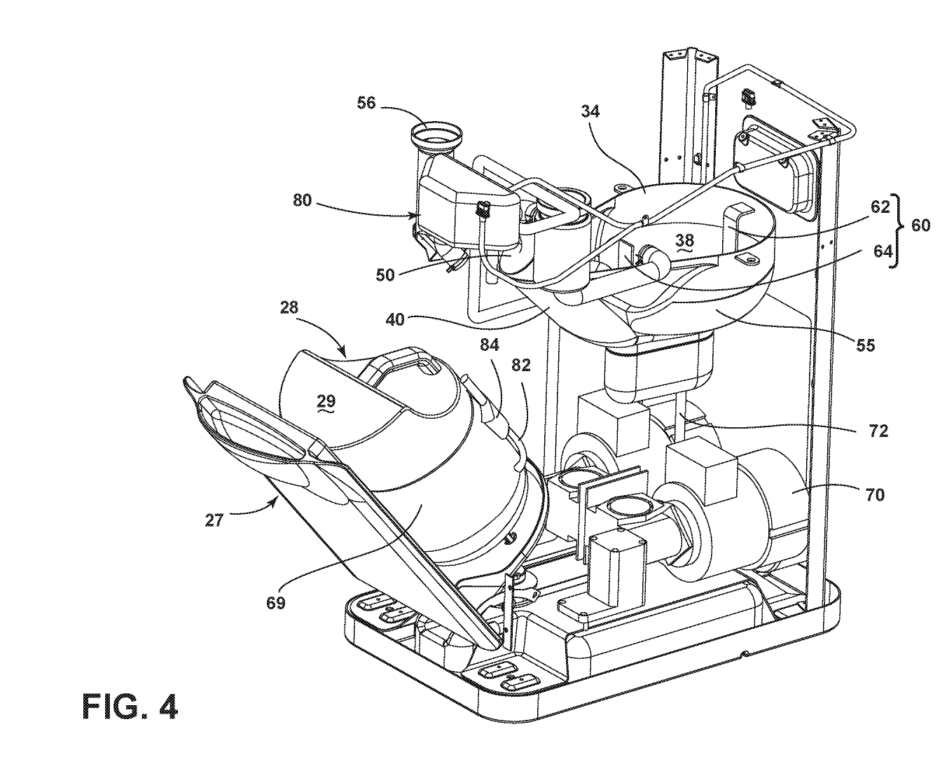

A first reducing mechanism 60 may be provided in the hopper 30. As illustrated in FIGS. 3 and 4, the first reducing mechanism 60 may be disposed at a lower portion of the hopper 30. The first reducing mechanism 60 may be in the form of a grinding wheel, a grinding blade, any chopping mechanism, or any like device or combination thereof that grinds, shears chops, mixes, breaks, or otherwise reduces the particle sizes of refuse by the operation of the first reducing mechanism 60 and/or uniformly mixing refuse with water, air or enzymes that may be introduced in the hopper 30 for transforming the refuse into compost.

The first reducing mechanism 60 may include first and second blades 62, 64 having different dimensions and shapes, respectively, while other configurations may be also possible for the first reducing mechanism 60. As illustrated, the first blade 62 may be horizontally extended and then angled in a vertical direction. The end portion of the first blade 62 may be bent again at a right angle. The second blade 64 may be in a curved shape for uniformly mixing the refuse received in the interior of the hopper 30, in combination of the first blade 62.

The container 28 may also include a second reducing mechanism 66 positioned at a lower portion of the container 28. The second reducing mechanism 66 in the container 28 may include at least one blade 68 for further reducing the dimension of materials and uniform mixing of materials in the container 28.

A second heating element 69 may also be provided to the container 28. As illustrated in FIG. 4, the second heating element 69 may be in the form of a blanket heater mounted to at least a portion of the exterior of the container 28 for providing heat energy into the interior of the container 28 by heat conduction. In another example, a sheath heater may be mounted to the exterior of the container 28. It may be understood that the second heating element 69 may be positioned in the interior of the container 28 and may be in direct contact with refuse in the container 28. In yet another example, the second heating element 69 may be provided to the container 28 in the form of an in-line heater having resistive heaters. At least one in-line heater may be operably mounted to the container 28 such that hot air may be supplied into the interior of the container 28 via heat convection.

A motor 70 may be provided in a lower portion of the cabinet 12 beneath the hopper 30 and the auger 50, and may be operably coupled to the first reducing mechanism 60 via a rotatable shaft 72. The second reducing mechanism 66 in the container 28 may be operably detachably coupled to the motor 70 by means of a pulley and a belt while other coupling mechanisms may be also possible for coupling the motor 70 and the second reducing mechanism 66. For example, combination of multiple mating gears such as small/large gears, rack and pinion etc., may operably couple the motor 70 and the second reducing mechanism 66.

The motor 70 may be a brushless permanent magnet (BPM) motor. Alternately, other motors such as an induction motor or a permanent split capacitor (PSC) motor may also be used. The motor 70 may be configured to operate the first reducing mechanism 60 at different speeds during the cycle of operation to facilitate the reducing and/or mixing of refuse in the interior of the hopper 30 and/or the container 28.

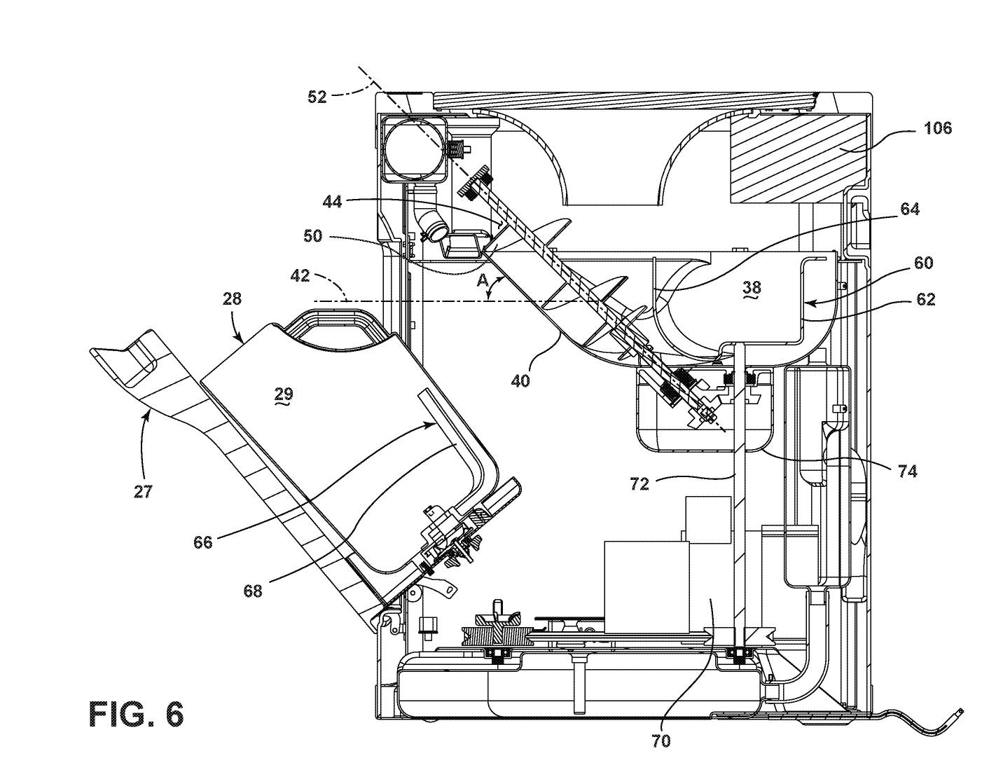

While the motor 70 may be directly coupled to the first reducing mechanism 60 in one embodiment, as illustrated in FIG. 6, a gear box 74 may be positioned vertically above the motor 70 for coupling the motor 70 and the first reducing mechanism 60. The gear box 74 may include a plurality of gears or racks and pinions for controlling the operating speed of the first reducing mechanism 60. The gear box 74 may also be coupled to the rotatable auger 50 for providing a rotational movement of the rotatable auger 50. Therefore, the first reducing mechanism 60 and the rotatable auger 50 may rotate concurrently.

In another embodiment, the operation of the first reducing mechanism 60 and the rotatable auger 50 may be separately controlled. The operation of the first reducing mechanism 60 and the rotatable auger 50 may be separately controlled by providing each of them with a separate motor. For example, a motor may be provided to each of the first reducing mechanism 60 and the rotatable auger 50 such that the rotational speed and/or rotational direction may be controlled independently from each other.

An air supply system may be provided to the composting device 10 for providing air flow into/out of the hopper 30 and/or the container 28. The air supply system may include a fan compartment 80 for supplying, drawing, and filtering air into and out of the hopper 30, and the fan compartment 80 may include a vacuum pump, a fan, and filter material. The fan in the fan compartment 80 may be fluidly coupled to a pre filter 78, which, in turn, is fluidly coupled to the hopper 30 via an air inlet tube 76 for supplying the air into the hopper 30. The pre filter 78 may typically be positioned at the upper portion of the cabinet 12, and may filter any unwanted dust from the air inlet.

The fan compartment 80 may be fluidly coupled to the outlet 44 of the hopper conduit 40. For example, the vacuum pump of the fan compartment 80 may be positioned adjacent to the outlet 44 for controllably drawing air with odors and/or microbes from the hopper 30 by operating the vacuum pump. Filter material, such as charcoal, positioned in the fan compartment 80 may filter odors and/or microbes from the air drawn from the hopper 30. It will be understood that the fan may also be fluidly coupled to the container 28 via an air supply inlet 81 for supplying filtered air downwardly into the container 28.

An air outlet tube 82 may fluidly extend from a portion of the container 28 for drawing the air from the container 28 to eliminate odors and/or microbes generated in the container 28 before the air is exhausted out of the composting device 10. The air outlet tube 82 may be coupled to an air filter 84, which may include a filter material. Filter material may include among other things charcoal, previously composted material and/or a biofilter material. While not shown, the operation of the air filter 84 may be controlled by the fan compartment 80.

A water supply system may be provided to the composting device 10 for providing moisture to the interior of the hopper 30 and/or the container 28. The water supply system may include a water fill conduit 86, which may be fluidly coupled to the water fill inlet 25 on the portion 23 of the top wall 20, for receiving water from outside of the composting device 10 into a water reservoir in the cabinet 12. At least one water reservoir may be provided for storing water received via the water fill conduit 86. As illustrated, a primary water reservoir 88 and an auxiliary water reservoir 90 are provided to the lower portion of the cabinet 12 and the back wall 16, respectively. It may be understood that the height of the auxiliary water reservoir 90 is configured to be higher than that of the primary water reservoir 88. The water fill conduit 78 may be fluidly coupled to the auxiliary water reservoir 90, which, in turn, may be fluidly coupled to the primary water reservoir 88 such that the water may be first received by gravity in the primary water reservoir 88 via a water conduit 92.

The water supply system may also include a water pump 94 for controllably providing water from the primary water reservoir 88 to the interior of the hopper 30 via a water inlet tube 96. As illustrated, the water pump 90 may be positioned adjacent to the primary water reservoir 88. An end portion of the water inlet tube 92 may be received in the upper portion of the conduit 40 of the hopper 30.

The composting device 10 may include one or more sensors 100 provided in one or more of the components of the composting device 10 to receive input from the sensors, which are known in the art and not shown for simplicity. Non-limiting examples of sensors 100 include: temperature sensors, humidity sensors (or moisture sensors), level sensors, odor sensors, pH sensors, water level sensor, temperature sensor, and weight sensors. For example, a humidity sensor may be provided to the interior of the hopper 30 and the container 28 respectively for determining the amount of humidity in the hopper 30 and the container 28. In another example, a level sensor may be provided to at least one of the hopper 30 or the container 28 to determine the amount of refuse or material the hopper 30 or the container 28. At least one water level sensor may be provided to at least one of the primary water reservoir 88 or auxiliary water reservoir 90 to determine the liquid level received in the water reservoir. A temperature sensor may be operably coupled to the interior of the hopper 30 for determining the temperature of refuse.

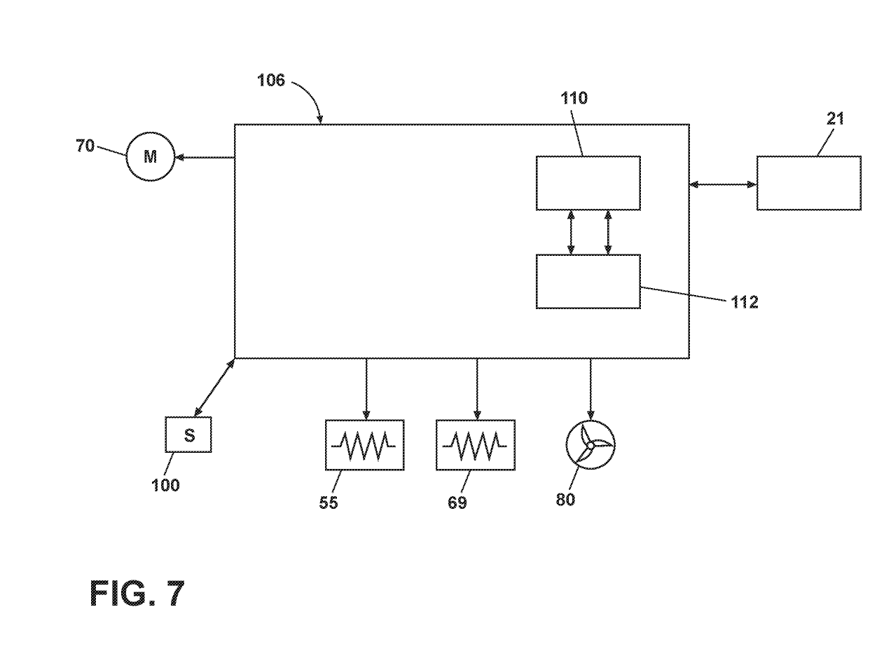

Referring now to FIG. 7, a schematic of the controller 106 for controlling the operation of the composting device 10 is illustrated. The controller 106 may be provided with a memory 110 and a central processing unit (CPU) 112. The memory 110 may be used for storing the control software that is executed by the CPU 112 in completing a cycle of operation using the composting device 10 and any additional software. The memory 110 may also be used to store information, such as a database or table, and to store data received from one or more components of the composting device 10 that may be communicably coupled with the controller 106.

The controller 106 may be operably coupled with one or more components of the compositing device 10 for communicating with and controlling the operation of the component to complete a cycle of operation. For example, the controller 106 may be operably coupled with the motor 70 to control the operation of the motor 70. In another example, the controller 106 may be operably coupled to the fan compartment 80 for selectively operating the vacuum pump and fan received in the fan compartment 80.

In yet another example, the controller 106 may also be operably coupled with the first and second heating elements 55, 69 for controllably providing heat energy to the heating elements 55, 69 according to a cycle of operation, for keeping the temperature and/or humidity in the hopper 30 and container 28 within a predetermined range.

The controller 106 may also be coupled with one or more sensors 100 provided in one or more of the systems of the composting device 10 to receive input from the sensors, which are known in the art and not shown for simplicity. Non-limiting examples of sensors 100 that may be communicably coupled with the controller 106 include: temperature sensor, humidity sensor, level sensor, odor sensor, pH sensor, water level sensor, temperature sensor, and weight sensor, which may be used to determine a variety of system characteristics, such as the amount of moisture in the refuse, the amount and/or temperature of the refuse in the hopper 30, or the water level in the primary or auxiliary water reservoir 88, 90.

In operation, refuse, such as organic food waste or leaves, may be provided by the user to the interior of the hopper 30 through the opening 24 of the top wall 20. The refuse may be supplied to the interior of the hopper 30 over a period of time until the volume or weight of the refuse satisfies a predetermined threshold, as determined by the level sensor or weight sensor. In one embodiment the period of time may be 30 days. The composting cycle may begin when the level of refuse reaches a predetermined level or it may begin as soon as refuse is placed in the hopper and run continuously. In another embodiment, the composting cycle may initiate as long as the level sensor or weight sensor determines that the refuse is received in the hopper 30.

The refuse may be uniformly mixed and decimated by rotating the reducing mechanism positioned at the lower portion of the hopper 30 at a predetermined speed according to the cycle of operation. Grinding may occur periodically. The refuse may also be provided with heat, water and/or aeration according to the cycle of operation to promote the decomposition of the refuse. During the composting process, worms, bacteria and fungi may further break up the refuse in a chemical process that converts the refuse into heat, carbon dioxide or ammonium, which may be beneficial as a fertilizer to the soil. The humidity level in the hopper 30 may be monitored by the humidity sensor such that the humidity may not decline below a predetermined level. In one example, the relative humidity in the interior of the hopper 30 and the container 28 may not go down below about 25% for preventing the refuse from being too dry.

During the composting process, first heating element 55 may be controllably operated to maintain the temperature in the hopper 30 within a predetermined temperature range. The predetermined temperature range may vary with the progress of composting process, and the temperature may be determined by the temperature sensor. By keeping the temperature within a predetermined range, the number of microbes undesirable to the composting process may be reduced. Further, the relative humidity level in the hopper 30 may also be controlled by controllably operating the first heating element 55 to enhance the overall rate of composting process. For example, the controlled operation of heating element 55 may be advantageous in reducing excessive humidity from wet organic food waste.

While the composting process proceeds in the hopper 30, the material in the hopper accumulates and may reach a predetermined level in approximately one month, whereupon the partially composted refuse is transferred from the hopper 30 to the container 28. Importantly, the container 28 is disposed beneath the outlet 44 when it is in the closed position. For transferring the refuse, the rotatable auger 50 may rotate about its rotational axis 52 to capture the refuse and move it upwardly to the open end portion of the conduit 40. The refuse may be moved downwardly by gravity to the container 28 through the downspout 54. Enzymes may be provided to the hopper 30 or the container 28 or both by the enzyme dispenser 56 for continuing and enhancing the composting process. The refuse may be further decomposed by controlling the amount of water and aeration in the refuse in the container 28.

It may be understood that the second heating element 69 may operate to keep the temperature and/or humidity of refuse within a predetermined level according to a cycle of operation. The composting process in the container 28 may take approximately one month before the composting process is complete and compost is available for use from the container 28.

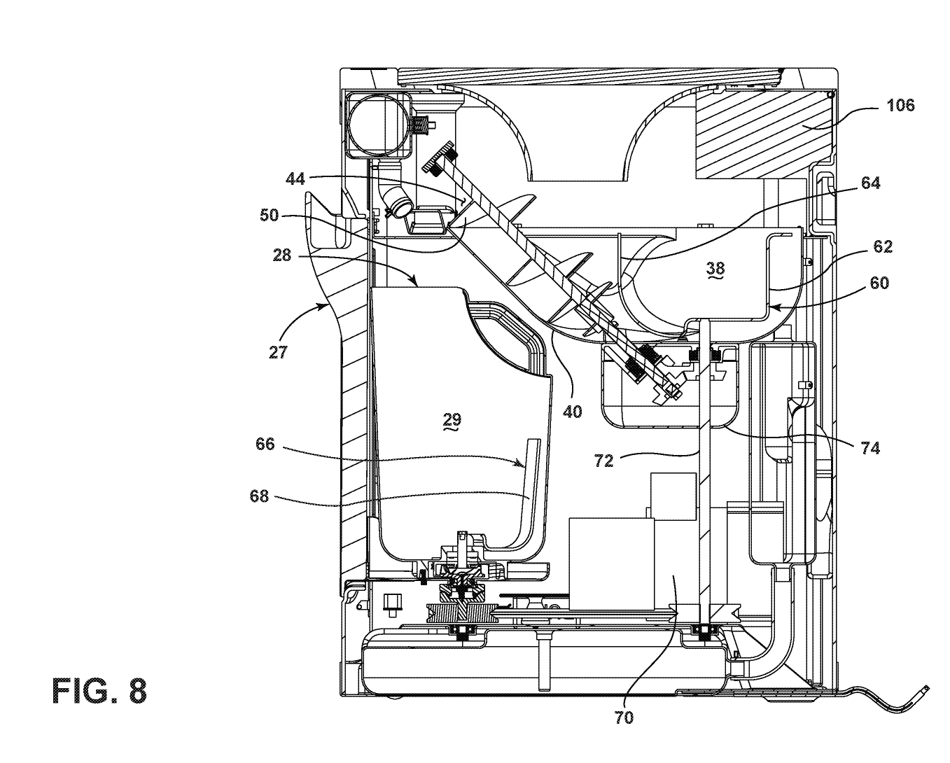

FIG. 8 is a cross sectional side view of the composting device 10 of FIG. 1, wherein the access door 27 is in the closed position. As illustrated, the container 28 may be coupled to the internal side of the access door 27, and may be positioned beneath the conduit 40 such that the container 28 and the end portion of conduit 40 are vertically aligned with each other. The shape of the container 28 may be such that the container 28 will not interfere with the conduit 40 extending upwardly with a predetermined angle relative to a horizontal axis. As a result, the container 28 may be positioned at least partially below the hopper 30. Furthermore, location of the container 28 may be adjusted to be adjacent to the motor 70 to further reduce the footprint of the composting device 10.

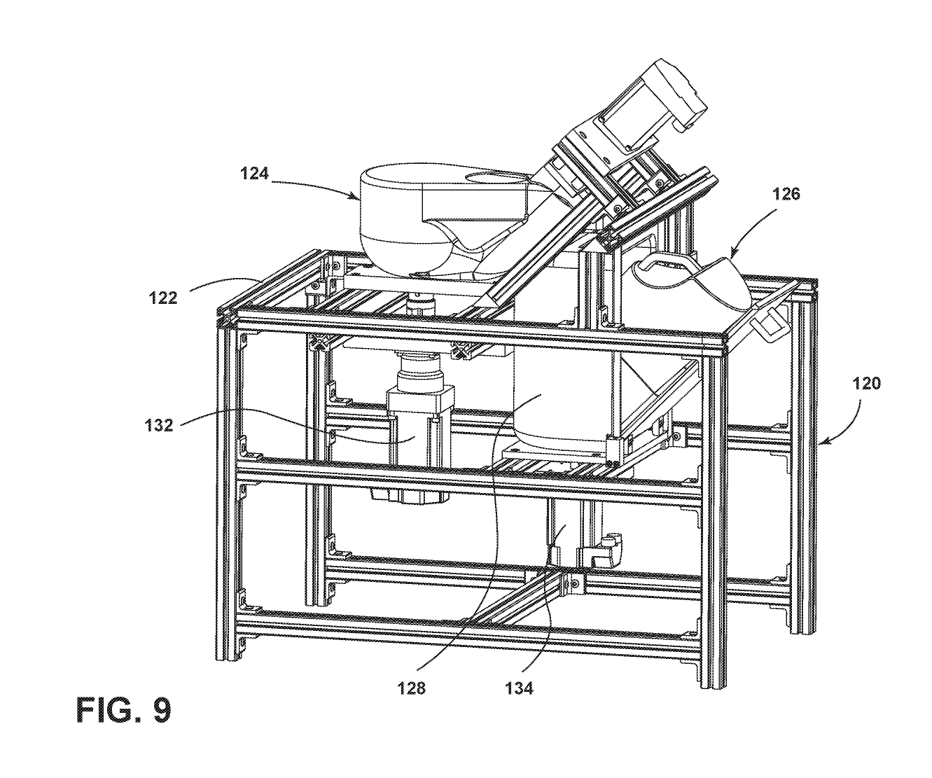

FIG. 9 is a perspective view of the composting device according to a second embodiment of the invention, where each of the auger and the reducing mechanisms for the hopper and the container is provided with a motor for independent operation. The composting device illustrated in FIG. 9 may otherwise be similar to the composting device 10 described above in having a hopper 124, a container 126 for transforming the refuse into compost by decomposing the refuse received in the hopper 124, and transferring the refuse into the container 126 for additional composting.

The primary difference between the first embodiment of the composting device 10 described above and the device in FIG. 9 may be the number of motors. As illustrated in FIG. 9, the hopper 124 and the container 126 are provided with motors 132, 134 which are dedicated for the operation of the hopper 124 and the container 126, respectively. The hopper 124 may be operably coupled to a motor 132, and the container 126 may be coupled to a motor 134. By providing a separate motor to the hopper 124 and the container 126, compost may be prepared in a controlled way and unnecessary power consumption may be avoided. For example, if the refuse is not provided into the hopper 30 due to an extended absence of the user, only the motor coupled to the container 28 is needed to operate to complete the transformation of the refuse into compost.

The composting device in FIG. 9 may also include a container holder 128 for holding the container 126. The composting device may be mounted to a stand 120 comprising a plurality of frame members 122 while the stand 120 may not be required in another embodiment. Any composting device having two motors may also be housed in a cabinet.

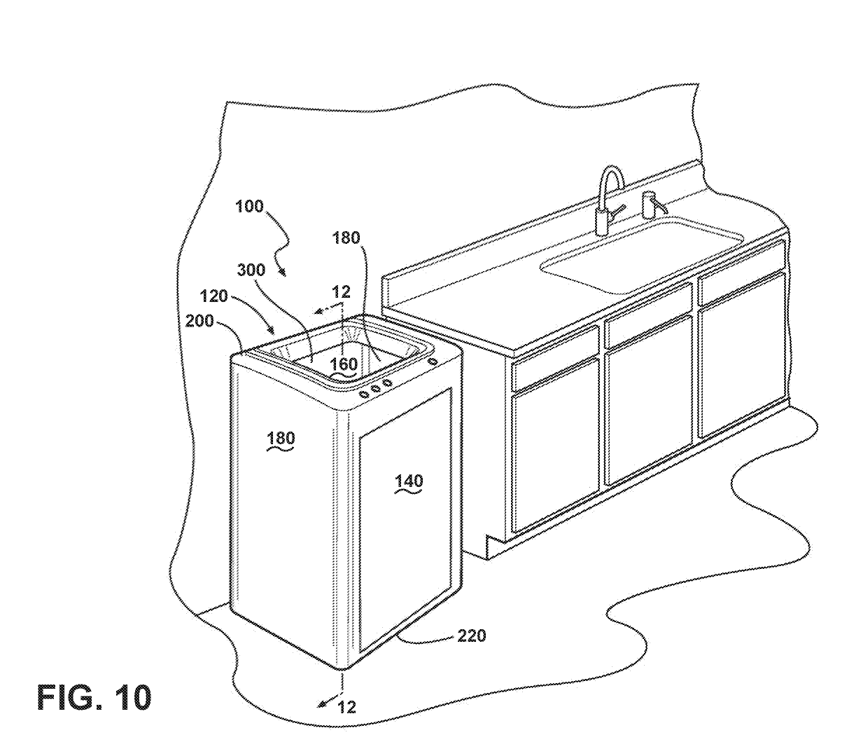

With reference to FIGS. 10-12, another embodiment of a device 100 for transforming refuse into compost is provided. The device 100 includes a housing 120 having a front wall 140 spaced apart a back wall 160, and a pair of side walls 180 extending between the front and back walls 140, 160. The housing 120 also includes a top wall 200 opposite a bottom wall 220. The housing 120 may be formed of a rigid and durable material such as steel, a metal alloy, or a hardened polymer composite material.

A first chamber 240 and a second chamber 260 are disposed within the housing 120. The first chamber 240 may include a bottom floor 28 spaced apart the top wall 200 and the bottom wall 220. The bottom floor 280 extends between the side, front and back walls 180, 140, 160 so as to enclose the first chamber 240.

The top portion of the first chamber 240 is enclosed by the top wall 200 of the device 100 and may include a first opening 300 for receiving refuse. The inner surfaces of the side walls 180, and front and back walls 140, 160 may be formed of or coated with a slick material such as stainless steel to help reduce the occurrence of refuse adhering to the inner surfaces of the first chamber 240. The first chamber 240 is configured to perform what is commonly referred to by those skilled in the art as an active composting process wherein refuse is primarily mechanically reduced to a plurality of small particulates. Thus, the ground refuse has a larger surface area which promotes the introduction of moisture and the aeration so as to help the decomposition process and transform the ground refuse into compost.

The second chamber 260 is connected to the first chamber 240 so as to allow ground refuse to be transported from the first chamber 240 to the second chamber 260. Preferably, the second chamber 260 is disposed beneath the first chamber 240 so as to allow gravity to assist with the deposition of ground refuse into the second chamber 260. In such an embodiment, the second chamber 260 may be enclosed by the bottom floor 280 of the first chamber 240 and the bottom wall 220 of the housing 120. The bottom floor 280 may include a partition 340. The partition 340 may be manually or automatically actuated so as to displace itself leaving an opening for which ground refuse may fall into the second chamber 260.

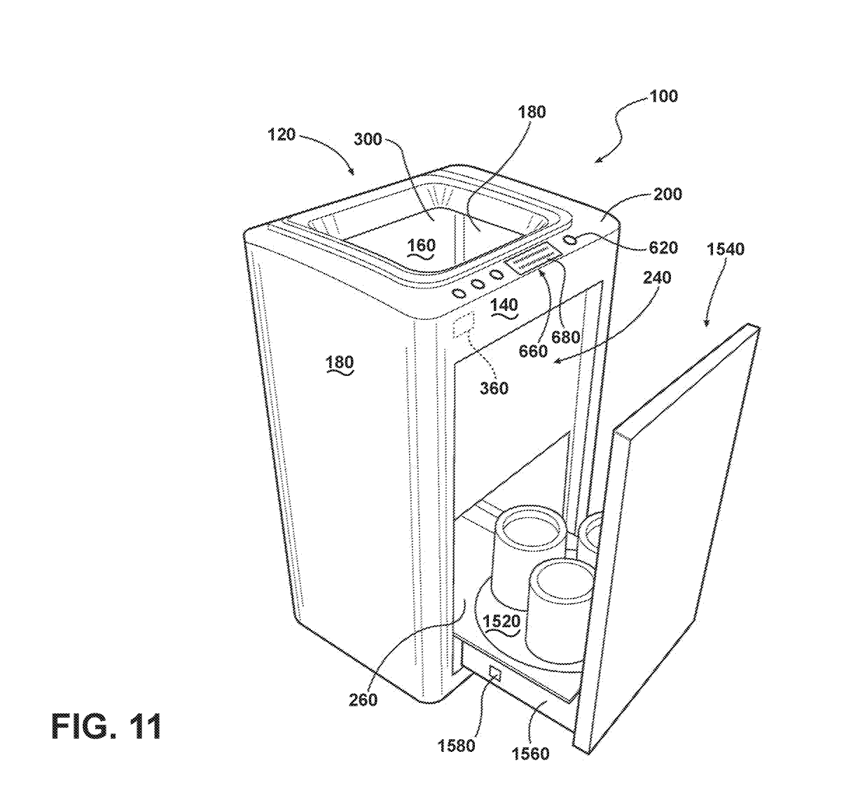

In a manual operation, the user may pull a lever or push one of the buttons on an outer surface of the housing 120, as seen in FIGS. 10 and 11, which displaces the partition 340 allowing the ground refuse to fall into the second chamber 260. In cases where the partition 340 is automatically actuated, a processor 360 may determine when grinding operations are complete and displace the partition 340.

The inner surfaces of the side walls 180, and the front and back walls 140, 160 may be formed of or coated with a slick material such as stainless steel to help reduce the occurrence of ground refuse adhering to the inner surfaces 320. The second chamber 260 is configured to provide a curing environment wherein the ground up refuse is no longer reduced in size through mechanical means but where mesophilic bacteria reaction of the refuse is operable to transform the ground refuse into compost suitable for use in farming.

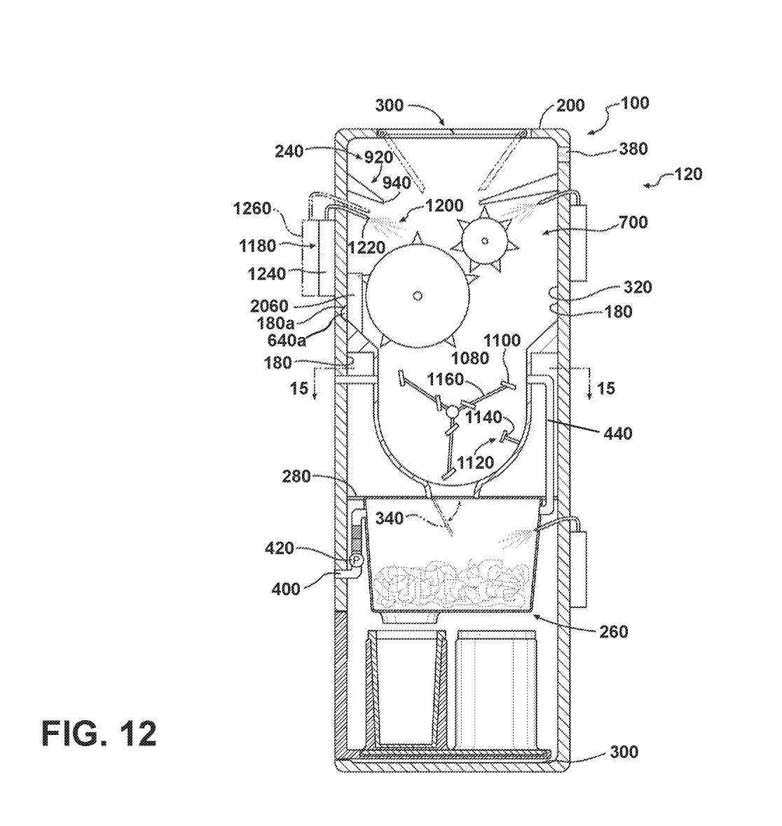

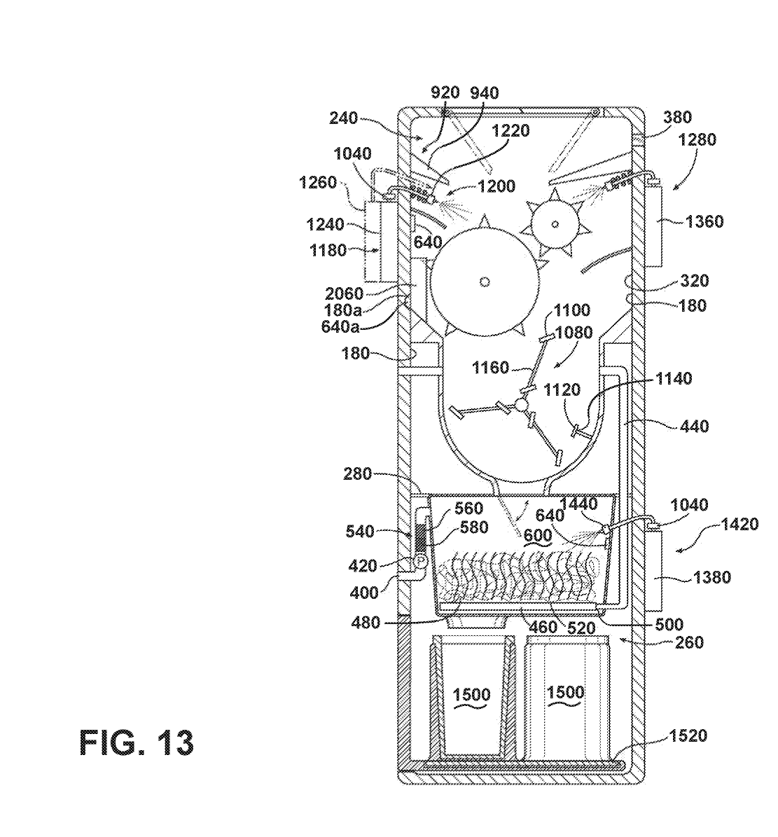

With reference again to FIG. 12, and now to FIG. 13, the device 100 may further include a fresh air intake 380 and an outtake 400. The fresh air intake 380 is in fluid communication with the environment. A blower 420 is operable to draw fresh air from the environment into the first chamber 240. A conduit 440 interconnects the first chamber 240 to the second chamber 260 so as to allow fluids to move therebetween. The conduit 440 may be removably attached to the first and second chamber 240, 260 or may be integrally formed thereto.

The conduit 440 and the blower 420 allow for the exchange of fluid resources between the first and second chambers 240, 260. Specifically, moisture found in the air may be transmitted from the first chamber 240 down to the second chamber 260. Likewise heat may be transferred and shared between the first and second chambers 240, 260 to optimize the active composting and curing process. The blower 402 is further operable to eject unwanted heat or moisture in the first and second chambers 240, 260 into the environment through the outtake 400.

With reference again to FIG. 13, the composting device 100 may further include a manifold 460 having a plurality of vents 480. The manifold 460 may further include a manifold intake 500 configured to engage the conduit 440. The conduit 440 may be formed of a rigid and durable material such as steel or a composite polymer. In such an embodiment, the conduit 440 is connected to a bottom inner surface 320 of the second chamber 260. The manifold 460 is disposed on the bottom inner surface 320 of the second chamber 260. The manifold 460 includes a support surface 520 for holding ground refuse undergoing the curing process. The vents 480 are dimensioned and configured to support the ground refuse and prevent the ground up refuse from falling through the vents 480. The manifold 460 may be formed as a separate unit so as to allow the user to remove the manifold 460 for cleaning, or may be integrated into the second chamber 260.

The blower 420 is operable to introduce air and moisture from the first chamber 240 into the second chamber 260. The blower 420 pushes air from the bottom portion of the second chamber 260 through the manifold 460. Specifically, air is pushed from the fresh air intake 38 through each of the plurality of vents 480. The air and moisture rise upwardly through the ground refuse held in the second chamber 260 and towards the first chamber 240. Thus moisture and heat from the first chamber 240 permeate through the ground refuse. The air may be recirculated or ejected through the outtake 400.

Alternatively the conduit 440 may be attached to a side wall 180 of the second chamber 260. The blower 420 draws air from the side wall 180 of the second chamber 260 through the outtake 400. The air is thus pulled over a top surface of ground refuse wherein moisture and temperature from the first chamber 240 are shared to particulates of ground refuse found near the top surface of the second chamber 260.

With reference again to FIGS. 12 and 13, the device 100 may further include a filter 540. The fresh air intake 380 is operatively connected to the first chamber 240 and is generally open to the environment. The outtake 400 is operatively connected to the second chamber 260. Air from the fresh air intake 380 is filtered through the filter 540 and drawn out the outtake 400.

The filter 540 is operable to capture odor emanating from within the first and second chambers 240, 260 and deliver a pleasant fragrance to the environment through the outtake 400. The filter 540 may include a first substrate 560 and a second substrate 580. The first substrate 560 is exposed to the inner space 600 of the second chamber 260 and the second substrate 580 is exposed to the environment. The first substrate 560 is formed of a material operable to filter odors such as charcoal. The second substrate 580 is operable to release a fragrance into the environment.

The blower 420 may be automated. A processor 360 receives information from a plurality of sensors 640 so as to actuate the blower 420 to optimize the composting process based upon the environmental conditions of the first and second chambers 240, 260. In particular, the composting process may be accelerated based upon the amount of moisture, or heat during the active composting process or the curing process. Sensors 640 operative to detect moisture and heat are currently known and used in the art, any such sensor 640 may be adapted for use herein, illustratively including a thermistor, thermocouple, conductivity sensor, capacitive or resistive humidity sensor, and/or thermal conductivity sensor.

For instance, a sensor 640 may be disposed within both or either of the first and second chambers 240, 260. The sensor 640 may be operable to detect the environmental condition of the first and second chambers 240, 260. The sensor 640 is in communication with the processor 36 and transmits the environmental condition of the respective first or second chamber 240, 260 to the processor 360. The processor 360 processes the environmental condition of the respective first or second chamber 240, 260, or in instances where sensors 640 are placed in both, of both the first and second chamber 240, 260. The processor 360 calculates a desired operating mode of the blower 420 which is optimal for the detected environmental conditions.

In one example the processor 360 processes the environmental conditions of a sensor 640 in the first chamber 240 and the environmental conditions of a sensor 640 in the second chamber 260 to actuate the blower 420. For example, in instances where a sensor 640 detects there is a relatively sufficient amount of moisture or heat in the first chamber 240 and another sensor 640 detects there is a sufficient amount of moisture or heat in the second chamber 260, the processor 360 actuates the blower 420 so as to direct moisture and thermal energy from the first chamber 240 to the second chamber 260 through the conduit 440.

It should also be appreciated that the blower 420 may be configured to blow air at a variable rate and the processor 360 is operable to adjust the rate of air flow based upon the environmental condition provided by the sensor 640. The processor 360 may actuate the blower 420 based upon other factors as well. For instance, the device 100 may include an input 620 operable to provide the processor 360 with the type of refuse being composted. A display 660 may provide the user with a menu 680. The menu 680 may include a list of different types of refuse from which the user may choose. Thus, the processor 360 may actuate the blower 420 so as to create a composting environment optimal for the type of refuse being composted. Thus, in instances where the refuse is comprised primarily of meat, the blower 420 may direct more moisture and heat to the second chamber 260.

The device 100 may include a plurality of sensors 640 operable to detect numerous environmental conditions wherein the plurality of conditions include the amount of ground refuse contained within the second chamber 260, the amount of moisture within the first and second chambers 24, 26, and the temperature within the first and second chambers 240, 260.

The device 100 includes a grinding mechanism 700 disposed in the first chamber 240. The grinding mechanism 700 is configured to grind the refuse into small parts so as to facilitate and expose the refuse to aeration, thus facilitating the composting process. The grinding mechanism 700 is operable to reduce the size of refuse into a uniform particle m size and dimension so as to optimize the ground refuse for aeration and facilitate the composting process. The grinding mechanism 700 is formed of a durable and rigid material such as steel or a steel composite.

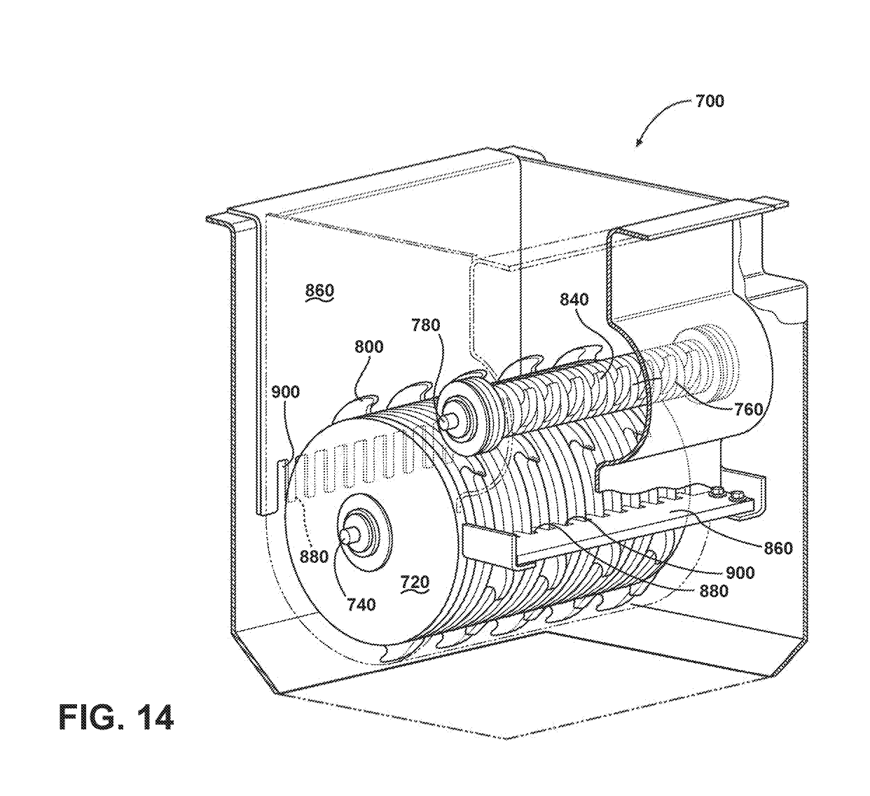

With reference now to FIG. 14, an embodiment of the grinding mechanism 700 is provided. The grinding mechanism 700 may include a first grinding wheel 720 mounted to a first shaft 740. The first shaft 740 is rotatable about a first axis. A second grinding wheel 760 is mounted to a second shaft 780. The second shaft 780 is rotatable about a second axis. The first and second axes are generally parallel to each other and spaced apart from each other. The grinding mechanism 700 extends longitudinally between the front and back walls 140, 160 of the first chamber 240 so as to place the first and second axes generally parallel with respect to the side walls 180 of the first chamber 240. The first and second axes are angled relative to each other with respect to a plane extending along the horizon. In other words, the first axis is above and generally offset radially from the second axis.

The first grinding wheel 720 has a first diameter and the second grinding wheel 760 has a second diameter. The first diameter is greater than the second diameter. Thus, the first grinding wheel 720 is larger in circumference than the second grinding wheel 760. The first grinding wheel 720 is disposed above the second grinding wheel 760 and adjacent the side wall 180 relative to the second grinding wheel 760.

The first grinding wheel 720 includes a plurality of first teeth 800 extending outwardly beyond an outer surface 820 of the first grinding wheel 720. The second grinding wheel 760 includes a plurality of second teeth 840 which also extend outwardly beyond an outer surface 820 of the second grinding wheel 760. The first and the second grinding wheels 720, 760 are spaced apart so as to place respective first and second teeth 800, 840 in sliding communication with the outer surface 820 of the respective first and second grinding wheels 720, 760. Accordingly, the grinding mechanism 700 is configured to grind refuse between the first and second grinding wheels 720, 760.

The grinding wheels 720, 760 are operable to rotate opposite each other so as to feed and introduce refuse between the first and second teeth 800, 840. It should be appreciated that in instances where the ground refuse is stuck between the grinding wheels 720, 760, the grinding wheels 720, 760 may be rotated in an opposite direction so as to eject the refuse.

The device 100 may further include a comb 860 having a plurality of comb teeth 880. The comb 860 may be disposed on the side wall 180. Each of the comb teeth 880 is spaced apart from the other and the second teeth 840 of the second grinding wheel 760 are configured to slide between each of the respective comb teeth 880 upon rotation of the grinding wheel so as to grind refuse therebetween. The comb 860 is further operable to prevent refuse from being stuck to a side wall 180 of the first chamber 240.

With reference again to FIG. 14, the comb 860 is shown mounted to one of the side walls 180. The comb 860 may be integrally formed to the side wall 180, or attached thereto. The comb 860 extends inwardly from the side wall 180 to the inner spaces 600 of the first chamber 240 along a plane generally parallel to the horizon. The comb teeth 880 extend from an inner surface 320 of the first chamber 240 toward the middle portion of the first chamber 240. The comb 860 may be removable so as to help facilitate cleaning the device 100.

The device 100 may include a pair of combs 860, one on each of the side walls 180. The combs 860 are operable to prevent refuse from passing through the spaces 900 between the second grinding wheel 760 and the side walls 180 so as to facilitate the introduction of refuse into the second chamber 260 through the process of being ground between the first and second grinding wheels 720, 760. The combs 860 are disposed within the first chamber 240 so as to position the comb teeth 880 to pass between the spaces 900 of respective first and second teeth 800, 840. Thus, one of the combs 860 is positioned along a plane which is generally parallel to the side wall 180. The comb teeth 880 are positioned to cooperate with the first teeth 80 of the first grinding wheel 720.

With reference again to FIGS. 12 and 13, a stopper 920 may be formed or disposed on the side wall 1800. The stopper 920 includes a plurality of stopping members 940 projecting outwardly and angularly from the side wall 180 towards the first grinding wheel 720 and second grinding wheel 760. Each stopping member 940 is configured to fit within the spaces between respective first and second teeth 800, 840. The stopping members 940 are operable to prevent refuse from being introduced into the space 90 between the second grinding wheel 760 and the side wall 180. The stopper 920 further ensures that refuse is introduced into the second chamber 260 between the first and second grinding wheels 720, 760.

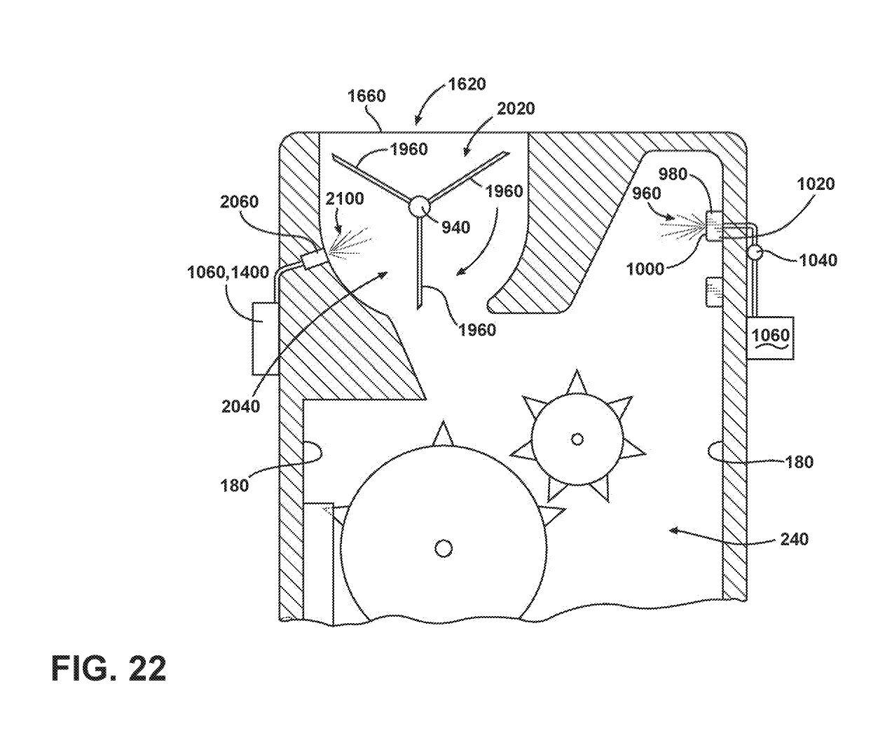

With reference again to FIGS. 12 and 13, and now to FIG. 22, the device 100 may further include a tenderizing device 960 operable to tenderize the refuse to facilitate grinding operations. The tenderizing device 960 may be a flash steamer 980. The flash steamer 980 is operable to flash steam the refuse prior to actuation of the grinding mechanism 700. The flash steamer 980 is operatively connected to the first chamber 240. The flash steamer 980 may include a vaporizer 1000 having a heating element 1020 and a pump 1040. A water source 1060 is connected to the flash steamer 980. The pump 1040 is operable to eject water from the water source 1060 through the vaporizer 1000 wherein the heating element 1020 heats the vaporized liquid to a predetermined temperature. Specifically, the vaporized liquid creates what is commonly referenced as flash steam environment wherein refuse is partially cooked. The partially cooked refuse is also infused with steam and thus is made more tender and may be ground up more easily relative to refuse which has not been flash steamed.

It should be appreciated by those skilled in the art that other tenderizing devices 960 may be adapted and used herein, illustratively including a microwave emitter, convection heater, infrared lamp, and/or resistive heater.

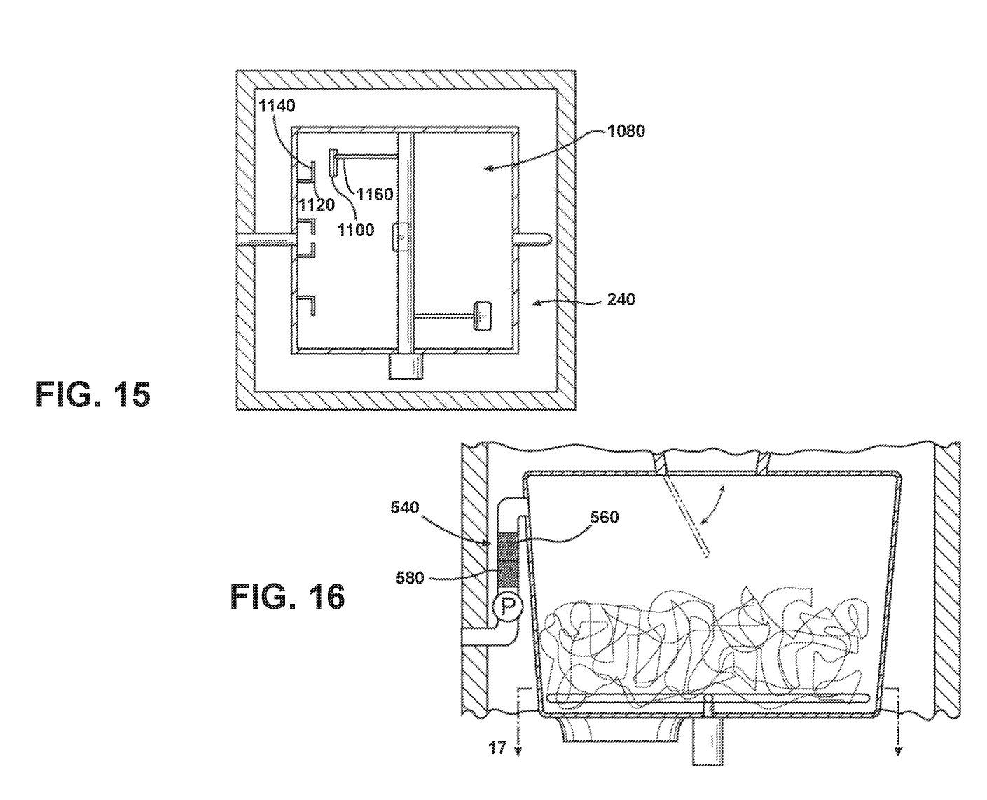

With reference again to FIGS. 12, 13 and now to FIG. 15, the first chamber 240 may further include a shearing device 1080. The shearing device 1080 includes a first cutting member 1100 rotatable about a third axis. A second cutting member 1120 is fixedly mounted to one of either the side, front, or back walls 180, 140, 160 of the first chamber 240. The first and second cutting members 1100, 1120 are formed from a durable and rigid material configured to maintain an edge.

The second cutting member 1120 includes a sliding surface 1140 exposed to a respective one of the side, front, or back walls 180, 140, 160 to which the second cutting member 1120 is mounted. The first cutting member 1100 is configured to slidingly engage the sliding surface 1140 of the second cutting member 1120 upon rotation about the third axis so as to create a shearing effect on ground refuse thus further minimizing the size of the ground refuse. The shearing device 1080 may include a plurality of first cutting members 1100. Each of the first cutting members 1100 has an elongated member 1160 extending radially from the third axis. Each of the elongated members 1160 is spaced apart from the other. At least one of the elongated members 1160 extends radially from the third axis at a different angle than the other elongated member 1160. Thus the first cutting members 1100 are all offset along the third axis and radially about the third axis.

The shearing device 1080 may disposed beneath the grinding mechanism 700. Thus gravity introduces refuse passed between the first and second grinding wheels 720, 760 into the bottom portion of the first chamber 240 and the shearing device 1080. The bottom floor 280 of the first chamber 240 may be arcuate and generally extends along a radius which is slightly longer than the length of the elongated members 1160 so as to allow the elongated members 1160 to come into sliding contact with the bottom surface 320 of the first chamber 240. Preferably, the bottom floor 280 is made or coated with a slick material such as stainless steel so as to facilitate the deposition of ground refuse into the second chamber 260.

With reference again to FIGS. 12 and 13, the device 100 may further include a cleaning mechanism 1180 configured to clean the first chamber 240. The cleaning mechanism 1180 is operable to facilitate the removal of refuse from the grinding mechanism 700. The cleaning mechanism 1180 may include a first sprayer 1200 configured to eject a cleansing agent into the grinding mechanism 700. The cleansing agent may include a liquid solvent or water, and is operable to help remove refuse from the surfaces of the grinding mechanism 700.

The first sprayer 1200 may be disposed above the grinding mechanism 700 and includes a first nozzle 1220 operable to direct the cleansing agent directly onto the grinding wheels 720, 760. The first nozzle 1220 may be disposed at various angles with respect to the first and second grinding wheels 720, 760 so as to apply a pressure water or liquid solvent treatment thereto. A first valve is operatively connected to the first nozzle 1220 so as to control the discharge and pressure of the cleansing agent.

The cleaning mechanism 1180 may include a first cartridge 1240. The first cartridge 1240 is configured to hold the cleansing agent. A pump 1040 is operable to eject the cleansing agent from the first cartridge 1240 through the first nozzle 1220 onto the grinding wheels 720, 76. The pump 1040 may be adjusted so as to discharge the cleansing agent at various pressures. In some instances, it may be desirable to apply a high pressure discharge to the grind wheels 720, 76 to help scrub off remaining refuse. In other cases, it may be advantageous to apply a low pressure to help saturate the grinding wheels 720, 760 to allow the cleansing agent time to dissolve the refuse.

Various cleansing agents are currently known and used in the art including water or chemical based cleaning agents such as ammonia which also includes various concentration mixes between water and ammonia. The cleansing agents disclosed herein are provided for illustrative purposes and should in no way be read as limiting.

The first cartridge 1240 may be removably attached to the first storage chamber. The first cartridge 1240 may be replaceable and includes a fitting unique to engage an opening of the first sprayer 1200. Thus when the cleansing agent is consumed, another first cartridge 1240 may be used to replace the consumed product, or the first cartridge 1240 may be refilled with a cleansing agent.

Alternatively, the device 100 may have a fresh water intake 1260 operable to connect the device 100 to a plumbed water source wherein pressure from the water source 1060 may be utilized to eject water onto the grinding wheel. However, it should be appreciated that the pump 104 may also be used to provide pressurized spray.

With reference again to FIGS. 12 and 13, the device 100 may also include a distributing mechanism 1280. The distributing mechanism 1280 is operatively connected to the first chamber 240. The distributing mechanism 1280 is operable to introduce a compost accelerant onto the refuse to facilitate the composting process. The distributing mechanism 1280 includes a second sprayer 1300 configured to eject the compost accelerant onto the refuse.

The distributing mechanism 1280 may be disposed above the grinding wheels 720, 760. It should be appreciated that the pump 1040 may be coupled to other devices operable to dispense a solvent. Accordingly the pump 1040 may be coupled to the distributing mechanism so as to be further operable to apply pressure to facilitate the discharge of the composting accelerant. Alternatively, the distributing mechanism 1280 may include a second pump 1320 (not shown) dedicated to the distribution of composting accelerant.

The distributing mechanism 1280 may further include a second nozzle 1340. The second nozzle 1340 is configured and oriented to apply the compost accelerant over a predetermined area within the first chamber 240. The second nozzle 1340 may distribute the compost accelerant in a fine mist so as to spread the compost accelerant over a larger surface 32 area relative to a stream. The second nozzle 1340 may be configured to be adjusted so as to vary the form of the discharged compost accelerant between a fine mist and a stream of liquid.

The compost accelerant may be composed of a bacteria such as a thermophilic bacteria which is operable to flourish in a heated environment wherein the active composting occurs. The distributing mechanism 1280 includes a second cartridge 1360 containing the compost accelerant.

A pump 1040 is operable to discharge the compost accelerant from the second cartridge 1360, through the second nozzles 1340 and onto a desired area. Preferably, the compost accelerant is applied directly on the refuse prior to grinding operations. The compost accelerant may include enzymes, probiotics, or other forms of bacteria operable to facilitate the transformation of the refuse into compost.

The second cartridge 1360 may be removably attached to the first chamber 240. The second cartridge 1360 may be either refilled with the compost accelerant or a replacement cartridge may be purchased. The second cartridge 1360 may include a fitting configured to specifically engage the second sprayer 1300. The second cartridge 1360 is fitted to engagingly connect to the second sprayer 1300.

The device 100 may include both a cleaning mechanism 1180 and the distributing mechanism 1280. In such an embodiment, the first and second cartridges 1240, 1360 may be operatively connected to the first nozzle 1220. The pump 1040 is downstream a valve. The valve is upstream the first nozzle 1220 and controls which of the first and second cartridges 1240, 1360, are in fluid communication with the first nozzle 1220.

The cleaning mechanism 1180 and distributing mechanism 1280 may be manually or automatically actuated. In the case of a manual system, the user simply actuates a button, dial or lever which controls the respective cleansing and distributing mechanism 1280. The device 100 may be configured so as to allow the user to vary the discharge pressure of the respective cleansing and distributing mechanism 1280. Additionally, the first nozzle 1220 may be manipulated so as to change the form for which the respective cleansing agent and compost accelerant are discharged.

In the case of a system wherein the cleansing and distributing mechanism 1280 are automatically actuated, the device 100 utilizes sensors 640 to detect an environmental condition wherein the use of a cleansing agent or compost accelerant is required or desired to optimize composting. For instance, a sensor 640 may be operable to detect the amount of refuse on the grinding mechanism 700. The amount of refuse is transmitted to the processor 360. The processor 360 may also process other information to determine if the cleaning mechanism 1180 should be actuated such as the operating state of the grinding wheels 720, 760, or the number of rotations the grinding wheels 720, 760 have executed. Thus, the processor 360 may actuate the cleaning mechanism 1180 when it determines that there is refuse on the grinding wheels 720, 760, the grinding wheels 720, 760 are not operating, and have completed a thousand revolutions since the last time the cleaning mechanism 1180 was actuated. In such a case, the process may actuate the cleaning mechanism 1180 so as to spray a cleaning agent onto the grinding mechanism 700.

The distributing mechanism 1280 may also be automatically actuated. For instance, the processor 360 may detect that the grinding wheels 720, 760 are operating and actuate the distributing mechanism 1280 so as to release the compost accelerant onto the refuse. Thus, the user provides no input 620 as to the amount or size of the refuse. Rather, the compost accelerant is introduced to the refuse solely upon the operation of the grinding mechanism 700. Alternatively, sensors 640 may detect the introduction of refuse into the first chamber 240 and transmit the information to the processor 360 wherein the processor 360 actuates the distributing mechanism 1280. Further, the processor 360 may be configured to process the amount and type of refuse introduced into the first chamber 240 and control the amount of compost accelerant being discharged.

The device 100 may include a plurality of second cartridges 1360, each of the plurality of second cartridges 1360 having a compost accelerant configured for a specific type of refuse. For instance, one of the second cartridges 1360 may contain a compost accelerant optimized to facilitate the composting of meat, whereas another of the second cartridges 1360 may contain a compost accelerant optimized to facilitate the composting of vegetables. The processor 360 may selectively actuate one or both of the second cartridges 1360 so as to apply discrete amounts of compost accelerant from each of the second cartridges 1360 to optimize the composting of the refuse being introduced into the first chamber 240.

Additionally the grinding mechanism 700 and shearing device 1080 may also be automated. In such a case, the device 100 may include an input 620 operable to provide a plurality of grinding operations to the user. For instance, the grinding operation may be based upon a heavy refuse load, a medium refuse load, or a light refuse load. For use herein heavy, medium, and light refer to the amount of refuse being introduced into the composting device 100. The amount may be based upon various known sizes such as one cup, two cups, or four cups. Upon selection, the grinding mechanism 700 and shearing device 1080 may be actuated for a predetermined period of time, at a variable rate of rotation, or a combination of both.

The grinding mechanism 700 and shearing device 1080 may be automatically actuated based upon other selectable inputs 620. The device 100 may be operable to perform and adjust the function of the grinding mechanism 700 and the shearing device 1080 based upon the type of refuse being introduced. For instance, a slow rotation of the grinding wheels 720, 760 may be preferable when the refuse consists of bone, whereas a rapid rotation of the grinding wheels 720, 760 may be preferable when refuse is introduced consisting primarily of vegetables.

Likewise, the rotation of the shearing device 1080 may further be adjusted based upon the amount of refuse being added or the type of refuse being added. Thus, the processor 360 may be operable to adjust the rate of rotation of the first cutting members 1100, or the number of revolution of the shearing device 1080 based upon the amount or type of refuse being added. The actuation of the shearing device 1080 and grinding mechanism 700 may be determined by a lookup table. The lookup table may provide a predetermined cycle of operation for the respective grinding mechanism 700 and shearing device 1080 based upon the amount or type of refuse being introduced. The processor 360 processes the lookup table to determine the correlating cycle of operation and actuates the grinding and shearing device 1080 accordingly. For use herein, a cycle of operation includes, but is not limited to the number of revolutions of the respective grinding mechanism 700 and shearing device 1080, and the rate at which the respective grinding mechanism 700 and shearing device 1080 is operated.

Thus, the device 100 may receive information regarding the refuse from a user input. The processor 360 selects a cycle of operation for both the grinding mechanism 700 and shearing device 1080 after processing the user input and lookup table. Upon completion of the selected cycle of operation of the grinding mechanism 700, the processor 360 actuates shearing device 1080 in the selected cycle of operation of the shearing device 1080. When the shearing device 1080 completes the selected cycle of operation, the processor 360 may further actuate the partition 340 so as to release the ground refuse into the second chamber 260.

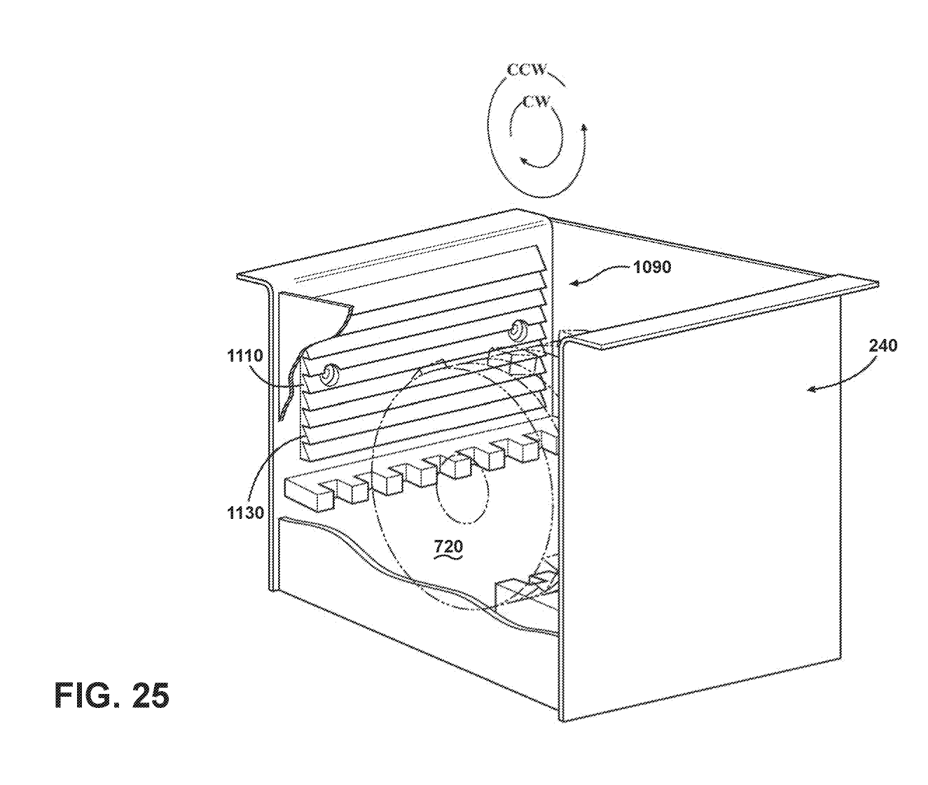

With reference now to FIG. 25, the first chamber may further include a baffle 1090 formed on one of the side walls 180 of the first chamber 240. The baffle 1090 may be formed of a durable and rigid material such as steel and may be mounted to the side wall 180 using mechanical fasteners such as a bolt. The baffle 1090 includes a base 1110. The base 1110 is a generally planar member configured to sit flush against the side wall 180. A plurality of ridges 1130 extend outwardly from the base 1110. The ridges 1130 are angled relative to the base 1110 so as to project downwardly toward the second chamber 260. The ridges 1130 extend along an axis oriented transversely between the front and back walls 140, 160 of the first chamber 240. The ridges 1130 are spaced apart from the outer surface of the first grinding wheel 720 and are generally parallel to the first shaft 740.

The baffle 1090 is operable to engage a generally circular object such as an apple so as to prevent the circular object from rotating free of the grinding mechanism 700. For example, as an apple is placed into the first chamber 240 for composting operations, the grinding mechanism is actuated. For illustrative purposes, assume the grinding mechanism is actuated so as to rotate clockwise as indicated by the arrow labeled “CW”. In instances where the apple is placed between the first grinding wheel 720 and the ridges 1130 of the baffle 1090, the ridges 1130 of the baffle 1090 engage the apple, preventing the apple from rotating and popping off the first grinding wheel 720. Likewise, in the event the first grinding wheel 720 is rotated counter-clockwise, the ridges 1130 of the baffle 1090 also engage the apple, preventing the apple from rotating and popping off the first grinding wheel 720. Accordingly, the baffle 1090 helps maintain an object, circular or otherwise, in engagement with the first grinding wheel 720 so as to assist in grinding operations. It should be appreciated by those skilled in the art that the baffle 109 may be used in conjunction with any grinding mechanism utilizing a rotational force to grind food matter into compost.

With reference again to FIGS. 12 and 13, the device 100 may further include a dispensing mechanism 1420. The dispensing mechanism 1420 is operable to dispense a curing agent into the second chamber 260. The dispensing mechanism 1420 includes a third nozzle 1440. The pump 1040 may be further operable to direct the curing agent onto the ground refuse disposed in the second chamber 260. It should be appreciated by those skilled in the art that the dispensing mechanism 1420 may include a third pump 1040 dedicated to the discharge of the curing agent. Alternatively the dispensing mechanism 1420 may be configured to allow gravity to supply the curing agent to the ground refuse.

The curing agent may include a mesophilic bacteria which is operable to facilitate the curing process of the ground refuse. A third cartridge 1380 containing the curing agent is removably attached to the third nozzle 1440. Upon consumption of the curing agent, the third cartridge 1380 may either be replaced or refilled with additional curing agents. The dispensing mechanism 1420 may include a plurality of third cartridges 1380, each having a curing agent formulated to optimize the transformation of a specific type of refuse into compost. For instance, refuse composed primarily of meat may require a different concentration or type of mesophilic bacteria than refuse composed primarily of vegetables.

Actuation and control of the dispensing mechanism 1402 may be done automatically. For instance, a sensor 640 may be operable to detect the introduction of ground refuse into the second chamber 260. The processor 360 is in communication with the sensor 640 and actuates the dispensing mechanism 1420 when the sensor 640 detects that ground refuse has been delivered into the second chamber 260.

With reference now to FIGS. 16, 17, and 18, the device 100 may further include an agitator 1460 disposed in the second chamber 260. The agitator 1460 is operable to stir the ground refuse so as to facilitate aeration throughout the ground refuse and thus the compost process. Specifically, the agitator 1460 is operable to agitate or stir up the ground refuse to prevent the ground refuse from settling and becoming solidified. The agitator 1460 is further operable to uniformly disrupt the ground refuse so that refuse found at the bottom of the pile is moved upwardly so as to be exposed to aeration.

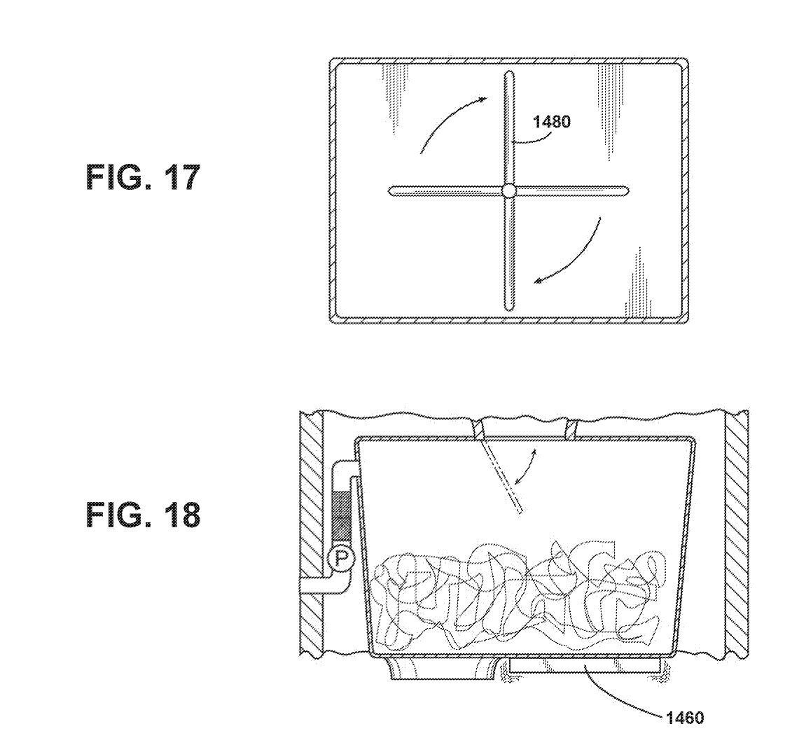

With reference to FIGS. 16 and 17, an embodiment of the agitator 1460 is provided. The agitator 1460 may include a rotary member 1480 operable to rotate about a fourth axis. The rotary member 1480 may rotate about a plane generally parallel to the bottom of the floor of the second chamber 260 or may rotate about an axis extending between the front and back walls 140, 160 of the second chamber 260. The rotary member 1480 is configured to stir the ground refuse.

With reference to FIG. 18, an alternative embodiment of the agitator 1460 is provided. The agitator may be operable to vibrate the ground refuse. In such instances the agitator 1460 includes a vibrating mechanism operable to vibrate a bottom portion of the second chamber 260. Vibrating mechanisms currently known and used in the art may be adapted for use herein. It should be appreciated that the agitator 1460 may include both a rotary member 1480 and a vibrating mechanism.

The agitator 1460 may be manually actuated or automatically actuated. In the case of automatic actuation the device 100 may have a display 660 and a user input 620 (shown in FIG. 11). The display 660 is operable to provide the user with a menu 680 having a plurality of operating programs from which to choose. The processor 360 receives a selected operating program from the user input 620. The operating program may include a specific command with respect to the distributing mechanism 1280, the operating cycles of the grinding mechanism 700 and shearing device 1080, a specific command with respect to the dispensing mechanism 1420, and/or a specific command with respect to the agitator 1460.

With reference now to FIGS. 11-13, and 16, the second chamber 260 may further include a plurality of curing containers 1500. The curing containers 1500 are disposed beneath the partition 340 and are configured to hold a discrete amount of ground refuse during the curing process. The curing containers 1500 may be formed of a durable and rigid material such as steel. The inner surfaces of the curing container 1500 may be impregnated with an active agent such as enzymes which are helpful in the breakdown of the refuse held therein.

Each of the curing containers 1500 is movable to a ready position wherein a curing container 1500 is positioned to receive ground refuse from the first chamber 240. For instance, upon actuation of the partition 340, the ground refuse is deposited into a curing container 1500 in the ready position. Alternatively, the ground refuse may be collected in a repository disposed in the second chamber and later transferred to a respective curing container 1500 as shown in FIGS. 12 and 13. The curing containers 1500 are removably disposed within the second chamber 260.

With reference again to FIG. 11, the curing containers 1500 may be mounted onto a platform 1520. The platform 1520 may be rotatable. The platform 1520 may be operable to rotate one of the plurality of curing containers 1500 so as to align an opening of the curing container 1500 in the ready position wherein the curing container 1500 is registered to receive the released ground refuse from the first chamber 240.

The second chamber 260 may further include a door 1540. The door 1540 is movable between an open and closed position. The door 1540 may be slidably mounted to the second chamber 260. The door 1540 may be slidably attached to the housing 120 along a pair of spaced apart rails. Alternatively, the door 1540 may be hinged so as to open and close with respect to a side wall 180.

A platform support 1560 is configured to support the platform 1520. The platform 1520 is disposed entirely within the second chamber 260 and is enclosed therein when the door 1540 is in the closed position. The platform support 1560 is a generally planar member and may be slidably mounted to the second chamber 260 along a pair of rails mounted to the inner surfaces 32 of respective side walls 180. The platform support 1560 may be slid in and out of the second chamber 260 so as to facilitate the extraction of a filled curing container 1500. In instances where the door 1540 is slidably mounted to the second chamber 260, the platform support 1560 may be formed to the door 1540 and extend orthogonally from a bottom end of the door 1540. The door 1540 may include a gasket along an outer edge so as to help prevent odors from escaping when the door 1540 is in the closed position.

The curing containers 1500 may be manually or automatically rotated. In the case of an automatic rotation, the processor 360 is operable to rotate the platform 1520 so as to position an empty curing container 1500 into the ready position to receive ground refuse and out of the ready position when the curing container 1500 is full. Thus, the full curing container 1500 may be emptied into a garden or its contents stored elsewhere until the curing process is complete.

A load sensor 1580 may be operable to detect the amount of refuse supported by the platform 1520. A load sensor 1580 may be used to detect the weight of each curing container 1500, or a single load sensor 1580 may be used to detect the weight of the entire platform 1520. Thus, a change in weight may be transmitted to a processor 360. The processor 360 processes the weight change to determine if a curing container 1500 is filled, wherein the platform 1520 is rotated so as to position a container in the ready position to a non-ready position. Thus, in this manner, a filled curing container 1500 may be positioned out of the ready position to allow an unfilled curing container 1500 to occupy the ready position. An indicator (not shown) may provide a notice to the user that the curing container 1500 is filled and moved out of the ready position. The indicator may be a light disposed on the door 1540 or an outer surface of the housing 120. Alternatively, the indicator may issue an acoustic notice such as a bell.

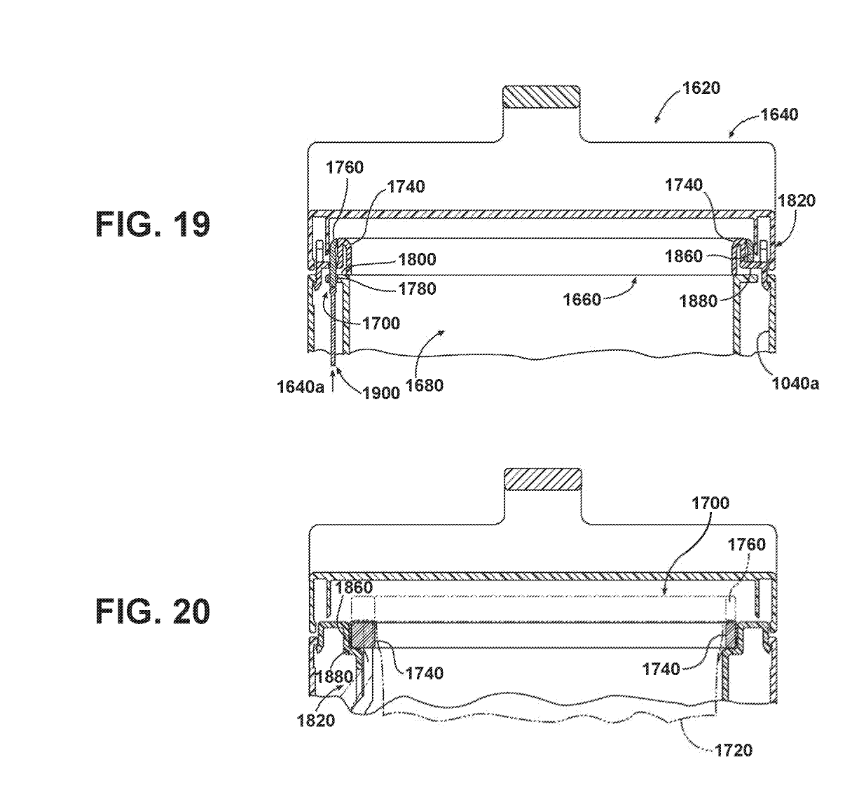

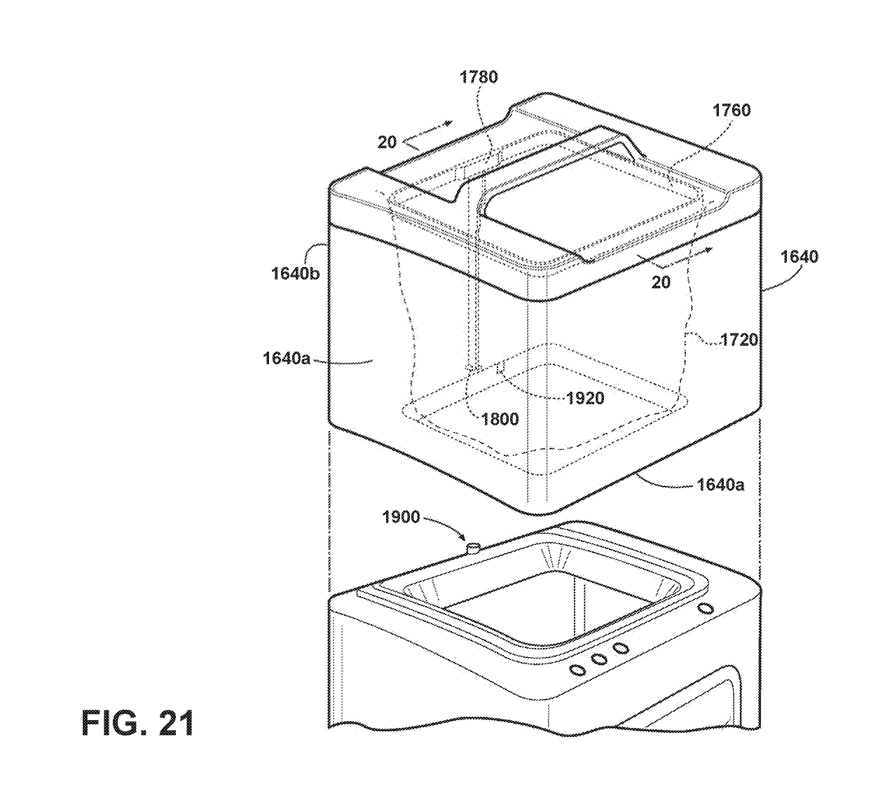

With reference now to FIGS. 19-20, the device 100 may further include a storage container 1620 configured to hold a discrete amount of refuse. Preferably, the storage container 1620 is configured to hold a day's worth of refuse. The storage container 1620 includes a top cover 1640 covering a top opening 1660, a pair of spaced apart container side walls 1640a, a container front and container back walls 1640b, 1640c bounding the storage space 1680. The top cover 1640 is spaced apart a container bottom wall 1640d, the top cover 1640 and container bottom wall 1640d each extend between respective container side, container front and container back walls 1640a, 1640b, 1640c so as to enclose the storage space 1680. The container bottom wall 1640d may be displaced so as to allow the contents of the storage container 1620 to drop. The top cover 1640 may be displaced so as to allow access to the storage space 1680. The storage container 1620 may be removably mounted onto the first chamber 240 so as to deposit refuse into the first chamber 240. The storage container 1620 may be placed in a kitchen area where refuse is discarded, and later mounted to the first chamber 240 wherein the contents are transferred.

The storage container 1620 may include a gripping mechanism 1700 operable to hold a bag 1720 within the storage space 1680 of the storage container 1620. In a preferred embodiment the top opening 1660 of the storage container 1620 is defined by a ribbed upper edge 1740. The gripping mechanism 1700 includes a continuous elongated member 1760 bounding an area generally the same shape as the top opening 1660 of the storage container 1620. The continuous elongated member 1760 may have a generally U-shaped cross section and is dimensioned to engage the ribbed upper edge 1740 of the top opening 1660 of the storage container 1620.

A bag 1720 may be placed over the ribbed upper edge 1740. Preferably the bag 1720 is formed of a decomposable material which is suited for composting. The continuous elongated member 1760 is placed onto the ribbed upper edge 1740 so as to grip a portion of the bag 1720 between the ribbed upper edge 1740 of the storage container 1620 and the U-shaped cross section of the gripping mechanism 1700.

The continuous elongated member 1760 may further include a projecting tab 1780. The projecting tab 1780 extends downwardly from the continuous elongated member 1760 when the continuous elongated member 1760 is engaged with the top opening 1660. The projecting tabs 1780 are registered to slide within a receiving aperture 1800 disposed adjacent the ribbed upper edge 1740 of the storage container 1620.

The gripping mechanism 1700 includes a retainer 1820 to help retain the gripping mechanism 1700 onto the opening of the storage container 1620 and hold the bag 1720 therebetween. In a preferred embodiment, the gripping mechanism 1700 is a magnetic clasp 1840. The magnetic clasp 1840 includes a first magnet 1860 is operable to engage a second magnet 1880. The first magnet 1860 is disposed on the gripping mechanism 1700, and the second magnet 1880 is disposed on the storage container 1620 so as to help secure the gripping mechanism 1700 therebetween.

An ejector 1900 is disposed adjacent the receiving apertures 1800 and operable to bias the projecting tabs 1780 upwardly so as to overcome the magnetic force of the magnetic clasp 1840 and separate the gripping mechanism 1700 from the ribbed upper edge 1740 of the storage container 1620. When separated, the bag 1720 is no longer gripped and is free from being held. The ejector 1900 may be actuated by an actuator 1920 disposed adjacent a bottom edge of the storage container 1620, or on the top surface of the device 100 as shown in FIG. 12.

Thus, when the storage container 1620 is mounted onto the opening of the first chamber 240, actuation of the ejector 1900 causes the bag 1720 and the entire contents of the bag 1720 to fall into the first chamber 240 to begin grinding operations. The ejector 1900 may be further operable to actuate the bottom partition 340 so as to simultaneously displace the bottom partition 340 and allow the bag 1720 and its contents to fall into the first chamber 240.

Thus, the storage container 1620 may be stored in the kitchen and refuse fit for composting may be stored in the storage container 1620 until the bag 1720 is full. The user may simply place the storage container 1620 on top of the first chamber 240. The placement of the storage container 1620 onto the first chamber 240 actuates the actuator 1920 which in tum ejects the protruding tabs from the receiving apertures 1800, while simultaneously displacing the bottom partition 340. Thus the bag 1720 is free to drop into the first chamber 240 without the user handling the bag 1720.

With reference now to FIG. 22, another embodiment of a storage container 1620 is provided. The storage container 1620 is fixedly mounted to top of the first chamber 240. The storage container 1620 includes a rotatable door 1940 disposed beneath the top opening 1660. The rotatable door 1940 is rotatable about an axis extending between the front and back walls 140, 16 of the storage container 1620.

The rotatable door 1940 includes at least two rotating panels 1960. Each of the rotating panels 1960 is spaced apart from each other so as to provide access to the first chamber 240 for refuse to be introduced. Preferably the rotatable door 1940 includes three rotating panels 1960. Preferably, the rotating panels 1960 are evenly spaced apart and are configured so that two of the panels 1960 may be registered to align with opposing edges of the top opening 1660. Two of the panels 1960 may be rotated such that the outer edges of the panels 1960 are in contact with opposing edges of the top opening 1660, presenting a compartment 2020 for which refuse may be introduced. The two panels 1960 may also be rotated so as to present a seal wherein access to the inner space of the storage container 1620 is not possible without further rotation of the door 154.

In operation, refuse is placed into the compartment 2020. The rotatable door 1940 is then rotated so that the refuse is delivered into the storage container 1620. The rotatable door 1940 may be further rotated wherein the rotating panels 1960 which previously defined the compartment 2020 are exposed to an inner cleaning chamber 2040. The inner cleaning chamber 2040 is defined by a generally arcuate member extending from a side wall 180 of the storage container 1620. The arcuate member follows a radius of curvature which is slightly longer than the length of the respective rotating panels 1960 as defined by the distance between the axis of rotation and the outer edge of the rotating panels 196. Thus the outer edges of the rotating panels 1960 may come into sliding contact with the arcuate member.

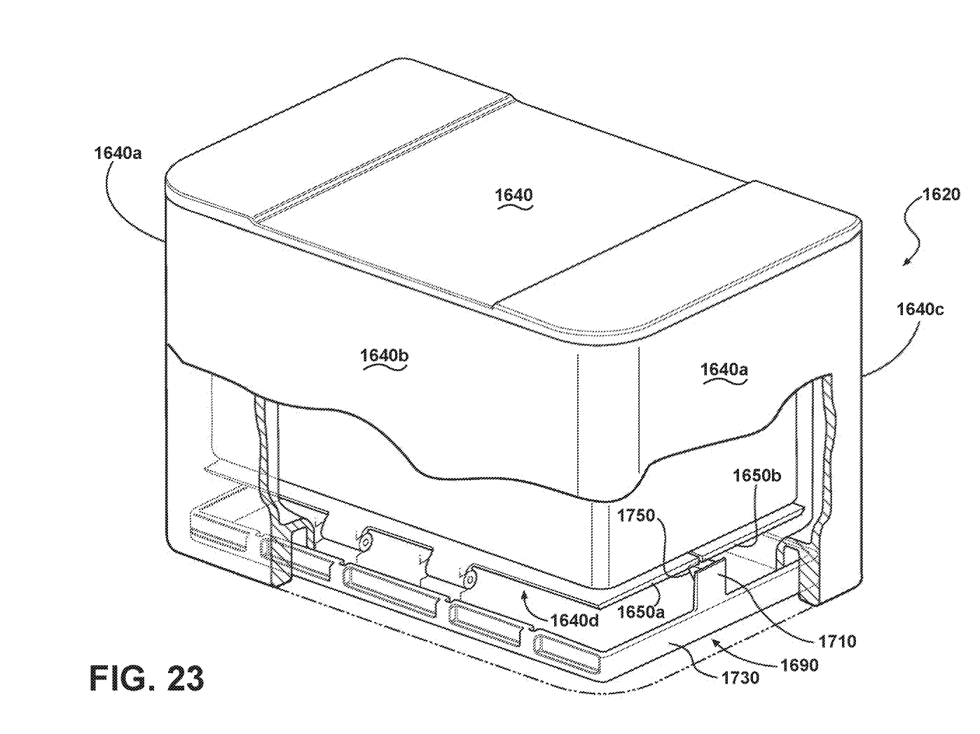

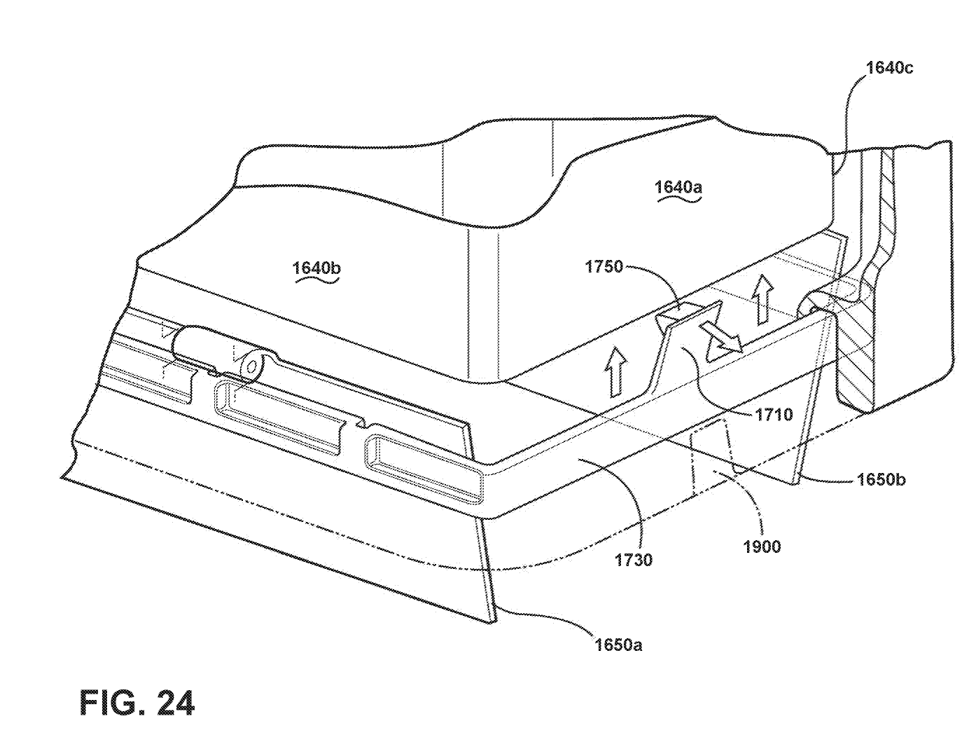

With reference now to FIGS. 23 and 24, yet another embodiment of the storage container 1620 is provided. The container bottom wall 1640d is displaceable with respect to the storage space 1680. In such an embodiment, the bottom wall 1640d includes a first panel 1650a spaced apart a second panel 1650b. The first and second panels 1650a, 1650b are pivotably mounted to opposite walls of the storage container 1620. For illustrative purposes, the first and second panels 1650a, 1650b are shown pivotably mounted to the container front and container back walls 1640a, 1640b. A pair of biasing members (not shown) may be operable to continuously urge respective first and second panels 1650a, 1650b downwardly with respect to the top cover 1640 of the storage container 1620. Alternatively, the first and second panels 1650a, 1650b may be operable to drop using gravity assist.

The release mechanism 1690 is operatively connected to the distal ends of both the first and second panels 1650a, 1650b. The release mechanism 1690 may include a resilient tab 1710 operable to displace free and clear of the first and second panels 1650a, 1650b. For example, the release mechanism 1690 may be disposed along a bottom edge of the storage container 1620. The release mechanism 1690 includes a release mechanism base 1730.

The release mechanism base 1730 is movable with a slot formed within the bottom edge of the storage container. The release mechanism base 1730 is movable between a first and second position. In the first position, the release mechanism base 1730 is adjacent the bottom edge of the slot, and in the second position, the release mechanism base 1730 is displaced upwardly with respect to the bottom edge.

The release mechanism tab 1710 extends upwardly from a top surface of the release mechanism base 1730. The tab 1710 includes a tab head 1750 which projects inwardly towards the inner space of the storage container 1620. The tab head 1750 includes a planar surface. As shown in FIG. 14, when the base 1730 is in the first position, the planar surface of the tab head 1750 supports the distal ends of respective first and second panels 1650a, 1650b, counteracting the biasing members, or weight of the first and second panels 1650a, 1650b, so as to keep the first and second panels 1650a, 1650b along a common plane.

With reference now to FIG. 24, the base 1730 is shown in the second position. The base 1730 is pushed upwardly from an ejector 1900 which is indicated by a dashed line. The ejector 1900 is disposed on the top surface of first chamber and extends upwardly beyond the top surface. The storage container 1620 is configured to sit upon the opening of the first chamber 240, wherein the first and second panels 1650a, 1650b are configured to pivot within the first storage chamber 240 so as to allow the bag to drop therein.

The storage container 1620 may be used adjacent the sink area and stored on the kitchen counter. The base 1730 of the release mechanism 1690 is positioned in the first position, and may be placed therein by operation of gravity or a biasing member urging the base 1730 away from an upper edge of the slot in which the base 1730 is seated. Thus, the first and second panels 1650a, 1650b are held on a common plane, and may support the weight of the bag and its content.

When the bag is full, the storage container 1620 may be seated onto the opening of the first chamber 240 of the composting device 100, wherein the ejector 1900 displaces the base 1703 upwardly into the second position, pushing the tab head 1750 past the first and second panels 1650a, 1650b. The biasing members operatively connected to respective first and second panels 1650a, 1650b are then free to urge the first and second panels 160a, 1650b down and outwardly so as to allow the bag to drop into the first chamber 240 wherein grinding operations occur. Alternatively, gravity may be used to allow the unsupported first and second panels 1650a, 1650b to pivot downwardly so as to allow the bag to drop into the first chamber 240.

The inner cleaning chamber 2040 may include a second cleaning mechanism 2060 operable to clean the two rotating panels 1960 which previously held refuse introduced into the first chamber 240. In a preferred embodiment, the second cleaning mechanism 2060 is a photo- catalytic device 2080 operable to produce a photo-catalytic reaction on the exposed rotating panels 1960 therein. In such an embodiment, the rotating panels 1960 may be formed of a titanium dioxide coating and the photo-catalytic device 2080 may be operable to generate a UV light. However, it should be appreciated that the second cleaning mechanism 2060 may be a third sprayer 2100 operatively connected to a water source 1060, a fourth cartridge 1400 having a cleansing agent, or the first cartridge 1240.

With reference again to FIGS. 12 and 13, the device 100 may further include a chamber heater 2060, the chamber heater is operable to selectively heat the first or second chambers 240, 260. A sensor 640, such as a thermistor 640a, is operatively connected to detect the temperature within the first or second chamber. The processor 360 processes the temperature of the first or second chamber 240, 260 and may actuate the chamber heater 2060 so as to generate a temperature operable to optimize the process for which the first and second chambers 240, 260 are configured to perform. The thermistor 640a may be disposed within a depression 180a formed on a side wall 180 of the first chamber 240 so as to prevent the grinding mechanism from damaging the thermistor 640a, further the thermistor 640a would be physically exposed and in contact with the refuse so as to provide a more accurate reading of the temperature of the refuse itself.

The processor may be further operable to process other information received from various sensors 640 within the first and second chambers 240, 260 to determine if the chamber heater 2060 should be activated. The processor 360 may take into consideration the minimal energy use needed to optimize the temperature in respective first and second chambers 240, 260. For instance, the processor 360 may decide to actuate the blower 420 in instances where there is sufficient heat in the first chamber 240 to heat the second chamber 260 to a desired temperature. In other instances, the processor may actuate the chamber heater 2060 to heat both the first and second chambers 240, 260 where a heat deficiency exists in both chambers 240, 260.

It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application. For example, other inventions arising from this disclosure may include any combination of the following concepts.

According to one aspect of the invention a device for transforming refuse into compost is provided. The device includes a first chamber, which may include a grinding mechanism. The grinding mechanism is configured to grind the refuse into small parts so as to facilitate and expose the refuse surfaces to aeration. It is known by those skilled in the art that exposure to aeration expedites the composting process.

A second chamber is attached to the first chamber. The second chamber is configured to store the ground refuse and provide a space optimal to cure the ground refuse into compost. The second chamber may be further configured to stir the ground refuse so as to prevent the ground refuse from solidifying and delaying the compost process. Ground refuse from the first chamber is dispensed into the second chamber.

Preferably the second chamber is disposed beneath the first chamber to allow gravity to deliver the ground refuse into the second chamber. In such an instance, a partition may be disposed between the first and second chambers. The partition may be manually or automatically actuated so as to create an opening and deposit the ground refuse from the first chamber to the second chamber.

The device may include tenderizing device operable to tenderize the refuse prior to grinding operations. The tenderizing device may be a flash steamer. The flash steamer is operable to flash steam the refuse prior to actuation of the grinding mechanism. The flash steamer may be disposed in the first chamber. The flash steamer may include a vaporizer having a heating element and a pump. A water source is connected to the flash steamer. The pump is operable to eject water from the water source through the vaporizer wherein the first heating element heats the vaporized liquid to a predetermined temperature. Specifically, the vaporized liquid creates what is commonly referenced as a flash steam environment wherein refuse is partially cooked.

A blower is operable to blow fresh air and thermal energy from the first chamber to the second chamber. The device includes a conduit which interconnects the first chamber to the second chamber. The conduit and the blower allow for the exchange of resources between the first and second chambers. Specifically, moisture found in the air may be transmitted from the first chamber down to the second chamber. Likewise heat may be transferred and shared between the first and second chambers to facilitate the composting process.

In one embodiment the conduit is connected to a bottom surface of the second chamber. In such an embodiment, the composting device may further include a manifold having a plurality of vents. The manifold may further include a manifold intake configured to engage the conduit. The manifold is disposed on the bottom surface of the second chamber and includes a support surface for holding ground up refuse during the curing process.

Air and moisture from the first chamber may be delivered to the second chamber by use of a blower. The blower pushes air from the bottom portion of the second chamber through the manifold. Specifically, air is drawn from the manifold intake and pushed through each of the plurality of vents. The air and moisture rise upwardly through the ground refuse and towards the first chamber so as to flow upwardly. The air may be directed to an outtake, or recirculated. Thus moisture and heat from the first chamber are filtered and permeated through the refuse found in the second chamber.

Alternatively one end of the conduit may be attached to a side wall of the second chamber. Air is pushed through the side wall of the second chamber to the outtake. The air is thus pulled over a top surface of ground refuse wherein moisture and temperature from the first chamber are shared to the particulates making up the ground refuse found near the top surface of the second chamber.

The device may further include a filter. The fresh air intake is disposed on the first chamber and is generally open to the environment. The outtake is disposed on the second chamber. Air from the fresh air intake is drawn from the environment and distributed and pushed through the outtake. The filter is operable to capture odor emanating from within the first and second chambers and deliver a pleasant fragrance to the environment through the outtake. The filter may include a first substrate and a second substrate. The first substrate is exposed to the inner space of the second chamber and the second substrate is exposed to the environment. The first substrate is formed of a material operable to filter odors such as charcoal. The second substrate is formed of a material operable to release a fragrance into the environment.

The blower may be operable to urge air and thermal energy from both the first and second chamber through the filter and out to the environment. The blower may be automated wherein a processor receives input from a plurality of sensors so as to actuate the device to optimize the composting process. For instance, a sensor may be disposed within either of the first and second chambers. The sensor may be operable to detect the environmental condition of the first and second chambers. The sensor is in communication with the processor and transmits a signal to the processor. The processor processes the signal for which the processor calculates a desired operating mode of the device which is optimal in light of the detected environmental conditions. It should be appreciated by those skilled in the art that the device may include a plurality of sensors operable to detect numerous environmental conditions. For example, the plurality of conditions may include the amount of ground refuse contained within the second chamber, the amount of moisture within the first and second chambers, and the temperature within the first and second chambers.

In one example, the processor processes the signal from the sensor to actuate the blower when a predetermined environmental condition is detected within the first or second chamber. In instances where there is a relatively sufficient amount of moisture or heat in the first chamber but not a sufficient amount of moisture or heat in the second chamber, the sensor is operable to detect and transmit the environmental conditions of the respective chambers to the processor. The processor may then actuate the blower so as to direct moisture and thermal energy from the first chamber to the second chamber through the conduit. It should also be appreciated that the blower may be configured to blow air at a variable rate and the processor is operable to adjust the rate of air flow based upon the signal provided by the sensor.

As stated above, the composting device includes a first chamber, which may have a grinding mechanism. The grinding mechanism is operable to reduce the size of refuse into particles generally uniform in size and dimension so as to optimize the ground refuse for aeration and facilitate the composting process. In one embodiment, the grinding mechanism includes a first grinding wheel rotatable about a first axis. A second grinding wheel is rotatable about a second axis. The first and second axes are generally parallel to each other and spaced apart from each other. The grinding mechanism extends longitudinally along the first axis so as to be between a front wall and back wall of the first chamber. Thus, the first and second axes are generally parallel with respect to the side walls of the first chamber. The first and second axes are angled relative to each other with respect to a plane extending along the horizon. In other words, the first axis is above and generally offset radially from the second axis.

The first grinding wheel has a first diameter and the second grinding wheel has a second diameter. The first diameter is less than the second diameter. The first grinding wheel is disposed above the second grinding wheel and adjacent the side wall relative to the second grinding wheel. The first grinding wheel includes a plurality of first teeth extending outwardly beyond an outer surface of the first grinding wheel. The second grinding wheel includes a plurality of second teeth which also extend outwardly beyond an outer surface of the second grinding wheel. The first and the second grinding wheels are spaced apart so as to place respective first and second teeth in sliding communication with the outer surface of the respective first and second grinding wheels.

The grinding mechanism is configured to grind refuse between the first and second grinding wheels. The first and second grinding wheels are operable to rotate opposite each other so as to feed and introduce refuse between the two grinding surfaces. It should be appreciated that in instances where the ground refuse is stuck the first and second grinding wheels may be rotated in an opposite direction so as to eject refuse caught therebetween.

The grinding mechanism may be actuated by a single motor using a configuration of gears. Alternatively, the driving mechanism may include two motors, each dedicated to a respective grinding wheel. In such an embodiment, the grinding mechanism may be operable to actuate the respective grinding wheels at different speeds so as to facilitate the grinding of refuse.

The first chamber may further include a comb having a plurality of comb teeth. The comb may be disposed on one of the side walls. Each of the comb teeth is spaced apart from the other and the second teeth of the second grinding wheel are configured to fit between each of the respective comb teeth upon rotation of the grinding wheel so as to grind refuse therebetween. The comb is further operable to prevent refuse from being stuck to the side wall of the first chamber. The comb is may be fixedly mounted to one of the side walls. The comb may extend outwardly from the side wall so as to lie along a plane generally parallel to the horizon. Alternatively, the comb may extend downwardly along a plane generally parallel to the side wall. The device may include a pair of combs, one on each of the side walls. The combs are operable to prevent refuse from passing through and between the spaces between the first and second grinding wheels and the side walls. The combs are further operable to facilitate the introduction of refuse into the second chamber through the process of being ground between the first and second grinding wheels.

A stopper may be formed or disposed on the one of the side walls. The stopper may include a plurality of stopping members projecting outwardly and angularly from the side wall towards the space between the first grinding wheel and second grinding wheel. The stopping members are operable to prevent refuse from being introduced into the spaces between the second grinding wheel and the side wall thus helping to ensure that food is introduced into the second chamber between the first and second grinding wheels.

The first chamber may further include a shearing device. The shearing device includes a first cutting member rotatable about a third axis. A second cutting member is fixedly mounted to one of either the side, front, or back walls of the first chamber. The second cutting member includes a sliding surface exposed to a respective one of the side, front, or back walls to which it is mounted. The first cutting member is configured to slidingly engage the sliding surface of the second cutting member upon rotation about the third axis so as to create a shearing effect on ground refuse thus further minimizing the size of the ground refuse.

The shearing device may include a plurality of first cutting members. Each of the first cutting members has an elongated member extending radially from the third axis. Each of the elongated members is spaced apart from each other. At least one of the elongated members extends radially from the third axis at a different angle than the other elongated member. Thus they are all offset both in space defined along the third axis and radially about the third axis.

The shearing device may be disposed beneath the grinding mechanism. Thus gravity introduces refuse passed between the first and second grinding wheels into the bottom portion of the first chamber and the shearing device. A bottom floor of the first chamber may be arcuate and generally extends along a radius which is slightly longer than the length of the elongated members so as to allow the elongated members to come into sliding contact with the first bottom surface of the first chamber.

The device may further include a cleaning mechanism operative to clean the first chamber. The cleaning mechanism is operable to facilitate the removal of refuse from the grinding mechanism. The cleaning mechanism may include a first sprayer configured to eject a cleansing agent into the grinding mechanism. The cleansing agent is a solvent operable to help remove refuse from the surfaces of the grinding mechanism.

The first sprayer may be disposed above the grinding mechanism and includes nozzles operable to direct the cleansing agent directly onto the first and second grinding wheels. The cleaning mechanism may further include a first cartridge containing the cleansing agent. A pump is operable to eject the cleansing agent from the first cartridge through the nozzles onto the grinding wheels. Various cleansing agents are currently known and used in the art including water or chemical based cleaning agents such as ammonia which also includes various concentration mixes between water and ammonia.

The first cartridge may be removably attached to the first storage chamber so as to make the first cartridge replaceable. Thus when the cleansing agent is consumed, another first cartridge may be used to replace the consumed product. Alternatively, the device may have a fresh water intake operable to connect the device to a plumbed water source. In such an embodiment, pressure from the water source may be utilized to eject water onto the first and second grinding wheels.

The device may also include a distributing mechanism. The distributing mechanism is operatively connected to the first chamber. The distributing mechanism is operable to introduce a composting accelerant onto the refuse to facilitate the composting process. The distributing mechanism includes a second sprayer configured to eject the compost accelerant onto the refuse. The compost accelerant may be composed of a bacteria such as a thermophilic bacteria which is conditioned to flourish in a heated environment optimal for active composting process.

The distributing mechanism may further include a second cartridge containing the compost accelerant. A pump is operable to eject the compost accelerant from the second cartridge. The compost accelerant may include enzymes, probiotics and/or other bacteria operable to facilitate the transformation of the refuse into compost. The second cartridge may be removably attached to the first chamber. Thus the second cartridge may be either refilled with the compost accelerant or a replacement cartridge may be utilized. The second cartridge is fitted to engagingly connect to the second sprayer.

The device may include both the cleaning mechanism and the distributing mechanism. The cleaning mechanism and distributing mechanism may be manually or automatically actuated. In an example of automated actuation, a sensor is operable to detect the amount of refuse on the grinding mechanism. The processor is operable to process the environmental conditions of the first taken from the sensors to determine that the first or second grinding wheel requires cleaning. The processer is further operable to actuate the cleaning mechanism so as to spray a cleaning agent onto the grinding mechanism.

The grinding mechanism and shearing device may also be automated. For instance, the device may include an input operable to provide a plurality of grinding operations to the user. In such a case, the device may further include a display having a menu. The menu includes a selection of grinding operations from which the user may select. The selection of grinding operations may be based upon a heavy refuse load, a medium refuse load, or a light refuse load. For use herein heavy, medium, and light refer to the amount of refuse being introduced into the composting device. The amount may be based upon various known sizes such as one cup, two cups, or four cups. Other selectable inputs may be based upon the type of refuse being introduced.

The processor may also be operable to perform and adjust the function of the grinding mechanism and the shearing device based upon the type of refuse being introduced. For instance, a slow rotation of the grinding wheels may be preferable when the refuse consists of bone, whereas a rapid rotation of the grinding wheels may be preferable when refuse is introduced consisting primarily of vegetables. Likewise, the rotation of the shearing device may further be affected by the amount of refuse being added or the type of refuse being added. These selections may be placed in a lookup table wherein upon selection of the amount or type of refuse being introduced, the lookup table provides a predetermined cycle of operation for the respective devices within the compost device.

The device may be operable to automatically perform certain functions without user input. For instance, the processor may be operable to automatically actuate the distributing mechanism when the grinding mechanism is actuated. Thus, the user provides no input as to the amount or size of the refuse. Rather, the compost accelerant is introduced to the refuse solely upon the operation of the grinding mechanism.

The device may further include a dispensing mechanism. The dispensing mechanism is operable to dispense a curing agent into the second chamber. The dispensing mechanism includes a dispensing nozzle and a pump operable to direct the curing agent onto the ground refuse disposed in the second chamber. Alternatively the nozzle may be disposed above the second chamber so as to allow gravity to supply the curing agent to the ground refuse.

The curing agent may include a mesophilic bacteria which is operable to facilitate the curing process of the ground refuse. A third cartridge containing the curing agent is removably attached to the nozzle. Upon consumption of the curing agent, the third cartridge may either be replaced or refilled with additional curing agents.

Actuation and control of the dispensing mechanism may be manually or automatically done. In an illustrative example of automation, a sensor may be operable to detect the introduction of ground refuse into the second chamber. The processor is in communication with the sensor and actuates the dispensing mechanism when the sensor detects that ground refuse has been delivered into the second chamber.

The device may include an agitator disposed in the second chamber. The agitator is operable to stir the ground refuse so as to facilitate the aeration of the ground refuse and thus the compost process. Specifically, the agitator is operable to agitate or stir up the ground refuse to prevent the ground refuse from settling and becoming solidified. The agitator is further operable to ensure that the refuse is uniformly moved so that refuse found at the bottom of the pile is moved upwardly so as to be exposed to aeration.

In one embodiment, the agitator may include a rotary member operable to rotate about a fourth axis. The rotary member may rotate about a plane generally parallel to the bottom of the floor of the second chamber or may rotate about an axis extending lengthwise between the front and back walls of the second chamber so as to be parallel between the opposing side walls. The rotary member is configured to stir the ground refuse. Alternatively the agitator may vibrate the ground refuse. In such instances the agitator includes a mechanism operable to vibrate a bottom portion of the second chamber.

The second chamber may further include a plurality of curing containers. Each of the curing containers is movable to a ready position wherein the curing container is positioned to receive ground refuse from the first chamber. The curing containers are removably disposed within the second chamber. The curing containers may be mounted onto a platform. The platform is rotatable. The partition may be further operable to deliver ground refuse into a respective curing container.

For instance, the second chamber may be disposed beneath the first chamber. The partition is operable to release ground refuse from the first chamber into the second chamber. The platform may be operable to rotate one of the plurality of curing containers so as to align an opening of the curing container in the ready position wherein the curing container is registered to receive the released ground refuse from the first chamber. The second chamber may further include a door mounted to the second chamber. The door includes a platform support. The platform support is configured to support the platform. The door is movable between an open and closed position. The platform is disposed entirely within the second chamber and is enclosed therein, the platform support being a generally planar member extending orthogonally from a bottom end of a first door panel.

The processor is operable to rotate the platform so as to position an empty curing container into the ready position. A load sensor may be disposed so as to detect the amount of refuse held by the platform wherein the platform is rotated so as to position a curing container in the ready position to a non-ready position when the container is filled with ground refuse and thus an empty container is then moved to the ready position, and the filled curing container may be emptied. An indicator may be provided so as to alert the user that the filled curing container needs to be emptied.

The device may further include a storage container having a storage space configured to hold a discrete amount of refuse. The first chamber includes a first opening and the storage container is configured to fittingly mount onto the first opening of the first chamber.

The storage container may include a gripping mechanism operable to hold a bag within the storage space of the storage container. In a preferred embodiment the gripping mechanism has a U-shaped cross section and is dimensioned to engage a ribbed upper edge of the opening of the storage container. A bag may be inserted within the storage container. Preferably, the bag is made of a compostable material.

The bag is placed over the ribbed upper edge. The gripping mechanism is placed onto the ribbed upper edge so as to grip a portion of the garbage bag between the ribbed upper edge of the storage container and the U-shaped cross section of the gripping mechanism.

The storage container may further include a release mechanism operable to separate the gripping mechanism from the ribbed upper edge. For instance, the gripping mechanism may further include a projecting tab and a magnetic clasp. The magnetic clasp includes a first magnet disposed on the gripping mechanism operable to engage a second magnetic clasp disposed on the storage container so as to help secure the gripping mechanism thereto.

The projecting tabs are registered to engage a pair of receiving apertures. An ejector is disposed adjacent the receiving apertures. The ejector is operable to bias the projecting members upwardly so as to overcome the magnetic force of the magnetic clasp and separate the gripping mechanism from the ribbed upper edge of the storage container thus releasing the bag from being held. When the storage container is mounted onto the opening of the first chamber, actuation of the ejector causes the bag and the entire contents of the bag to fall into the first chamber to begin grinding operations.

In another embodiment of a storage container, the storage container includes a top opening and a rotatable door disposed beneath the top opening. The rotatable door is rotatable about an axis extending between front and back side walls of the storage container. The rotatable door includes at least two panels extending radially from a shaft coaxial with the axis. Each of the panels is spaced apart from each other so as to provide access to the first chamber for refuse. Preferably the rotating door includes three panels.

The panels are evenly spaced apart and are configured so that two of the panels may be registered to align with opposing edges of the opening so as to present a seal wherein the contents and access to the inner spaces of the storage container are not possible without further rotation of the door. The refuse may be placed into the space defined by the top opening and the exposed panels. The door is then rotated so that the refuse is delivered into the storage container. As the refuse is passed, the door may be further rotated wherein the two panels are exposed to an inner cleaning chamber. The inner cleaning chamber includes a photo-catalytic device operable to produce a photo-catalytic reaction within the inner cleaning chamber and the exposed panels therein. The panels may be formed of a titanium dioxide coating and the photo-catalytic device may be operable to generate a UV light.

The bottom floor of the storage container may be displaceable from one of a pair of side walls. The storage container may further include a bottom wall displaceable so as to provide access to the first chamber. The bottom wall may include a first panel spaced apart a second panel, wherein the first and second panels are pivotably mounted to opposite walls of the storage container. The device may also include a release mechanism operatively connected to the distal ends of oth the first and second panels. The release mechanism may be operable to retain the first and second panels along a horizontal plane, and to disengage the first and second panels so as to allow the first and second panels to displace downwardly so as to provide access to the first chamber.

In another embodiment, the device further includes a baffle disposed on one of the side walls of the first chamber. The baffle may include a base that is a generally planar member configured to sit flush against the side wall. The baffle may further include a plurality of ridges extending outwardly from the base, and each of the plurality of ridges may be angled relative to the base so as to project downwardly toward the second chamber. The ridges may extend along an axis oriented transversely between the front and back walls of the first chamber.

Another embodiment provides a compact composting device by positioning the container at least underneath the hopper, and upwardly extending the conduit having the rotatable auger such that the container and the end portion of the conduit are vertically aligned to each other. Additionally, the combination of two separate chambers, hopper and the container, makes the overall composting process faster and more efficient by sequentially transforming the refuse into compost in two separate chambers. The composting device in the claimed invention may be advantageous in that smaller and efficient composting device may be located in the household for hygienically transforming the organic food waste into compost.

To the extent not already described, the different features and structures of the various embodiments may be used in combination with each other as desired. That one feature may not be illustrated in all of the embodiments is not meant to be construed that it may not be, but is done for brevity of description. Thus, the various features of the different embodiments may be mixed and matched as desired to form new embodiments, whether or not the new embodiments are expressly described. All combinations or permutations of features described herein are covered by this disclosure. The primary differences between the exemplary embodiments relate to the cabinet, the frame, the existence and location of the access door, the accessibility of the container, the mounting of the container, the location and number of reducing mechanisms, the heater, the location and number of motors, and these features may be combined in any suitable manner to modify the above embodiments and create new embodiments. As examples, the first and second reducing mechanisms may be linked to a single motor, and the auger linked to a different motor. The first reducing mechanism and the auger may be linked to a single motor, and the second reducing mechanism to a different motor. Any combination of motors and reducing mechanism may be in a cabinet or a frame. Any of the foregoing combinations may have a container mounted to the access door or mounted separately in the cabinet.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A device for transforming refuse into compost, the device comprising:
a cabinet;
a first chamber configured to receive refuse;
a first reducing mechanism in the first chamber operable to grind the refuse;
a transfer mechanism disposed in a conduit extending upwardly from the first chamber to an outlet in the upper portion of the cabinet;
a motor beneath the first chamber and the transfer mechanism and operably connected to the first reducing mechanism and the transfer mechanism to operate the first reducing mechanism and the transfer mechanism;
a container removably mounted within the cabinet adjacent the motor and beneath the outlet to receive ground refuse from the outlet, wherein the container is accessible from outside the cabinet; and
a cleaning mechanism operative to clean the first chamber.

2. The device of claim 1 wherein the transfer mechanism extends to a point above the container.

3. The device of claim 1 wherein the container is located at least partially below the first chamber.

4. The device of claim 1 wherein the container is located at least partially above the motor.

5. The device of claim 1, further comprising an access door movably connected to a side of the cabinet between open and closed positions, wherein the container is removably mounted to the access door and located adjacent the motor and beneath the outlet when the access door is in the closed position.

6. The device of claim 5 wherein the access door is pivotally connected to the cabinet.

7. The device of claim 6 wherein the pivotal connection is on a horizontal axis.

8. The device of claim 5 wherein the access door is slidable between the open position and the closed position.

9. The device of claim 5 wherein the first reducing mechanism comprises at least one of a grinding wheel or a grinding blade.

10. The device of claim 5 wherein the cabinet is configured to be positioned under a countertop.

11. The device of claim 5 wherein the container comprises a second reducing mechanism operably connected to the container.

12. The device of claim 11 wherein the second reducing mechanism is operably coupled to the first reducing mechanism in the first chamber.

13. The device of claim 11 wherein each of the first and second reducing mechanisms and the auger is driven by a motor.

14. The device of claim 1 wherein the first reducing mechanism comprises at least one of a grinding wheel or a grinding blade.

15. The device of claim 1 wherein the cabinet is configured to be positioned under a countertop.

16. The device of claim 1 wherein the container comprises a second reducing mechanism operably connected to the container.

17. The device of claim 16 wherein the second reducing mechanism is operably coupled to the first reducing mechanism in the first chamber.

18. The device of claim 16 wherein each of the second reducing mechanisms and the transfer mechanism is driven by a motor.
